(19) United States
(12) Patent Application Publication
(10) Pub. No.: US 2025/0179795 A1
(43) Pub. Date: Jun. 5, 2025

(54) ORGANIC COMPOSITE INSULATED WALLS AND ROOF MEMBERS

(71) Applicant: NUtech Ventures, Lincoln, NE (US)

(72) Inventors: Joel Foderberg, Edwards, CO (US); Marc Maguire, Lincoln, NE (US)

(73) Assignee: NUtech Ventures, Lincoln, NE (US)

(21) Appl. No.: 18/959,185

(22) Filed: Nov. 25, 2024

Related U.S. Application Data
(60) Provisional application No. 63/549,952, filed on Feb. 5, 2024.
(60) Provisional application No. 63/605,278, filed on Dec. 1, 2023.

(51) Int. Cl. E04C 2/288; B32B 3/08; B32B 7/022; B32B 7/027; B32B 13/02; B32B 13/04; E04B 2/00; E04B 5/02

(52) U.S. Cl. CPC E04C 2/288; B32B 3/08; B32B 7/022; B32B 7/027; B32B 13/02; B32B 13/04; B32B 2307/304; B32B 2307/54; B32B 2607/00; E04C 2/46; E04C 2/50

(57) ABSTRACT

A composite panel may be a three-layer composite panel including a bottom concrete layer, a middle insulation layer, and a top concrete layer. The middle insulation layer may include an insulation material which is selected to insulate the bottom concrete layer from the top concrete layer. The insulation material may include organic materials to reduce or eliminate the carbon footprint of the composite panel. The composite panel may include trusses which connect between the bottom concrete layer and top concrete layer through the middle insulation layer. The trusses may include prestress strands disposed in the bottom concrete layer and top concrete layer, truss webs, and joints which join the prestress strands and the truss webs.

### CROSS-REFERENCE TO RELATED APPLICATIONS

The present application claims the benefit under 35 U.S.C. § 119(e) of U.S. Provisional Application Ser. No. 63/605,278, filed Dec. 1, 2023, titled “ORGANIC COMPOSITE INSULATED WALLS AND ROOF MEMBERS”, and U.S. Provisional Application Ser. No. 63/549,952, filed Feb. 5, 2024, titled “ORGANIC COMPOSITE INSULATED WALLS AND ROOF MEMBERS”, which are incorporated herein by reference in the entirety.

### TECHNICAL FIELD

The present invention generally relates to the field of elements of relatively thin form for the construction of parts of buildings, and more specifically to sheet materials, slabs, or panels.

### BACKGROUND

Insulated concrete walls are rapidly gaining popularity. The insulated concrete walls have superior insulation capabilities when compared to other wall systems. Fabrication of these systems is currently highly customized and labor intensive. The rigid insulation materials that are normally used (e.g., expanded polystyrene (EPS), extruded polystyrene (XPS), polyisocyanurate (POLYISO), etc.) require labor to prepare and their fabrication process is harmful to the environment due to chemical blowing agents and energy use. Insulated concrete walls, floor and roof members are sustainable but not generally considered environmentally friendly. Therefore, it would be advantageous to provide a device, system, and method that cures the shortcomings described above.

### SUMMARY

A composite panel is described, in accordance with one or more embodiments of the present disclosure. The composite panel may include a bottom concrete layer, a middle insulation layer, a top concrete layer, and a plurality of trusses. The plurality of trusses may include a plurality of prestress strands. The plurality of prestress strands may be disposed in the bottom concrete layer and the top concrete layer. The plurality of trusses may include a plurality of truss webs and a plurality of joints. The plurality of joints may join the plurality of truss webs to the plurality of prestress strands.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A depicts a perspective view of a composite panel, in accordance with one or more embodiments of the present disclosure.

FIG. 1B depicts a perspective view of the composite panel with a top concrete layer and a middle insulation layer which are hidden to illustrate trusses of the composite panel, in accordance with one or more embodiments of the present disclosure.

FIGS. 1C-1D depict a partial cross-section view of a longitudinal span of the composite panel, in accordance with one or more embodiments of the present disclosure.

FIG. 1E depicts a cross-section view of a longitudinal span of the composite panel, in accordance with one or more embodiments of the present disclosure.

FIG. 2 depicts a perspective view of a truss of the composite panel including a continuous truss web, in accordance with one or more embodiments of the present disclosure.

FIGS. 3A-3B depict perspective views of the truss of the composite panel including an open-looped segmented truss web, in accordance with one or more embodiments of the present disclosure.

FIGS. 3C-3D depict a front view of an open-looped segmented truss web, in accordance with one or more embodiments of the present disclosure.

FIG. 4A depicts a perspective view of the truss of the composite panel including a double-looped segmented truss web, in accordance with one or more embodiments of the present disclosure.

FIGS. 4B-4E depict a front view of a double-looped segment of a double-looped segmented truss web, in accordance with one or more embodiments of the present disclosure.

FIGS. 5-6 depict a partial cross-section view of a width of the composite panel including a double-ended hook joint, in accordance with one or more embodiments of the present disclosure.

FIGS. 7A depict a partial cross-section view of a longitudinal span of the composite panel including a truss lock joint, in accordance with one or more embodiments of the present disclosure.

FIGS. 7B depict a partial cross-section view of FIG. 7A, in accordance with one or more embodiments of the present disclosure.

FIGS. 8A depict a partial cross-section view of a longitudinal span of the composite panel including a hanger lock joint, in accordance with one or more embodiments of the present disclosure.

FIGS. 8B-8D depict a partial cross-section view of a width of the composite panel including a hanger lock joint, in accordance with one or more embodiments of the present disclosure.

FIG. 8E depicts a side view of a hub of a hanger lock joint, in accordance with one or more embodiments of the present disclosure.

FIG. 9A depicts a partial side view of a longitudinal span of the composite panel including a double-ended hook lock joint, in accordance with one or more embodiments of the present disclosure.

FIG. 9B depicts a partial cross-section view of a width of the composite panel including a double-ended hook lock joint, in accordance with one or more embodiments of the present disclosure.

FIG. 9C depicts a top view a double-ended hook lock joint, in accordance with one or more embodiments of the present disclosure.

FIG. 10 depicts a partial cross-section view of a width of the composite panel including a middle insulation layer defining a void space, in accordance with one or more embodiments of the present disclosure.

FIG. 11 depicts a partial cross-section view of a width of the composite panel including an embed plate and headed studs, in accordance with one or more embodiments of the present disclosure.

FIG. 12A depicts an elevation view of a system including composite panels, windows doors, fasteners, and frames, in accordance with one or more embodiments of the present disclosure.

FIGS. 12B-12D depict a cross-section views of FIG. 12A, in accordance with one or more embodiments of the present disclosure.

FIGS. 13A-13B depict a cross-section view of corner joints of composite panels which are orthogonal, in accordance with one or more embodiments of the present disclosure.

FIG. 14 depicts a cross-section view of corner joints of composite panels which are coincident, in accordance with one or more embodiments of the present disclosure.

FIG. 15 depicts a flow diagram of a method, in accordance with one or more embodiments of the present disclosure.

FIGS. 16A-16B depict extruding a bottom concrete layer, in accordance with one or more embodiments of the present disclosure.

FIG. 16C depicts extruding a middle insulation layer, in accordance with one or more embodiments of the present disclosure.

FIG. 16D depicts extruding a top concrete layer, in accordance with one or more embodiments of the present disclosure.

FIG. 17A depicts a perspective view of the composite panel with a top concrete layer and a middle insulation layer which are hidden to illustrate trusses of the composite panel, in accordance with one or more embodiments of the present disclosure.

FIG. 17B depicts a depicts a perspective view of the truss, in accordance with one or more embodiments of the present disclosure.

FIG. 18 depicts a perspective view of the composite panel, in accordance with one or more embodiments of the present disclosure.

### DETAILED DESCRIPTION OF THE INVENTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are generally directed to a composite panel. The composite panel may be a three-layer composite panel including a bottom concrete layer, a middle insulation layer, and a top concrete layer. The middle insulation layer may include an insulation material which is selected to insulate the bottom concrete layer from the top concrete layer. The insulation material may include organic materials to reduce or eliminate the carbon footprint of the composite panel. The composite panel may include trusses which connect between the bottom concrete layer and top concrete layer through the middle insulation layer. The trusses may include prestress strands disposed in the bottom concrete layer and top concrete layer, truss webs, and joints which join the prestress strands and the truss webs.

U.S. Pat. No. 10,309,105B2, titled “System for insulated concrete composite wall panels”; U.S. Pat. No. 9,493,946B2, titled “Tie system for insulated concrete panels”; U.S. Patent Publication No. U.S.20150167303A1, titled “Tie system for insulated concrete panels”; U.S. Pat. No. 6,837,013B2, titled “Lightweight precast concrete wall panel system”; U.S. Patent Publication No. U.S.20230047807A1, titled “Hemp based geopolymer compositions and methods of use thereof”; are each incorporated herein by reference in the entirety.

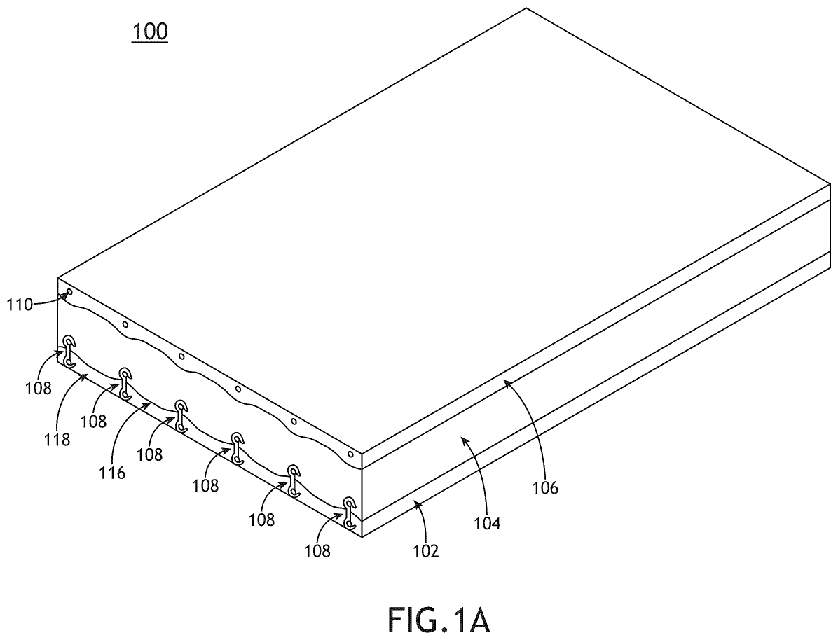

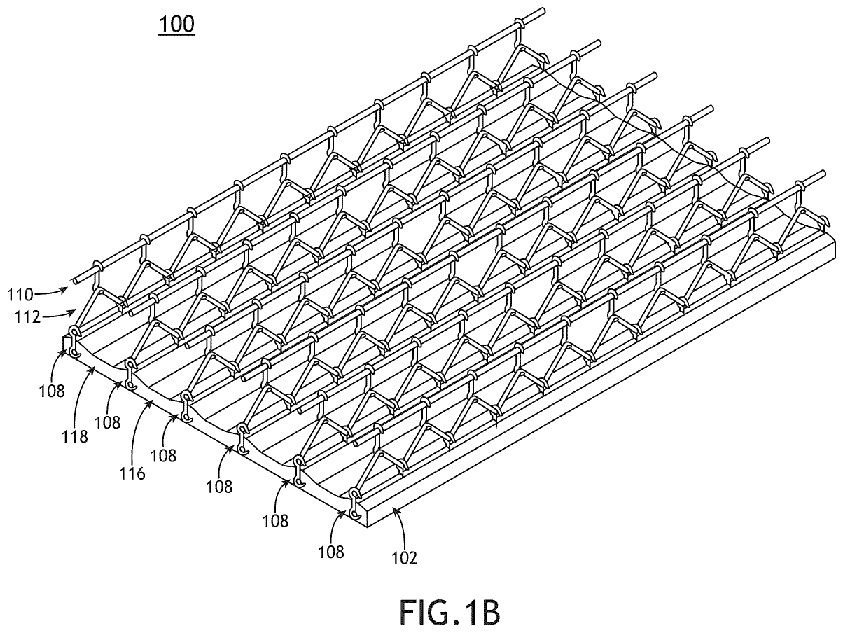

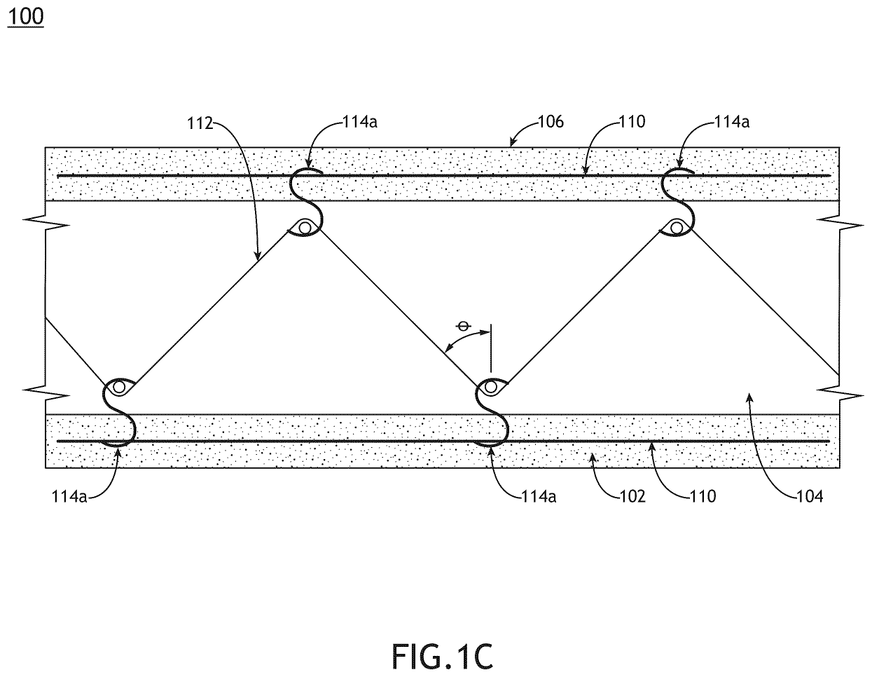

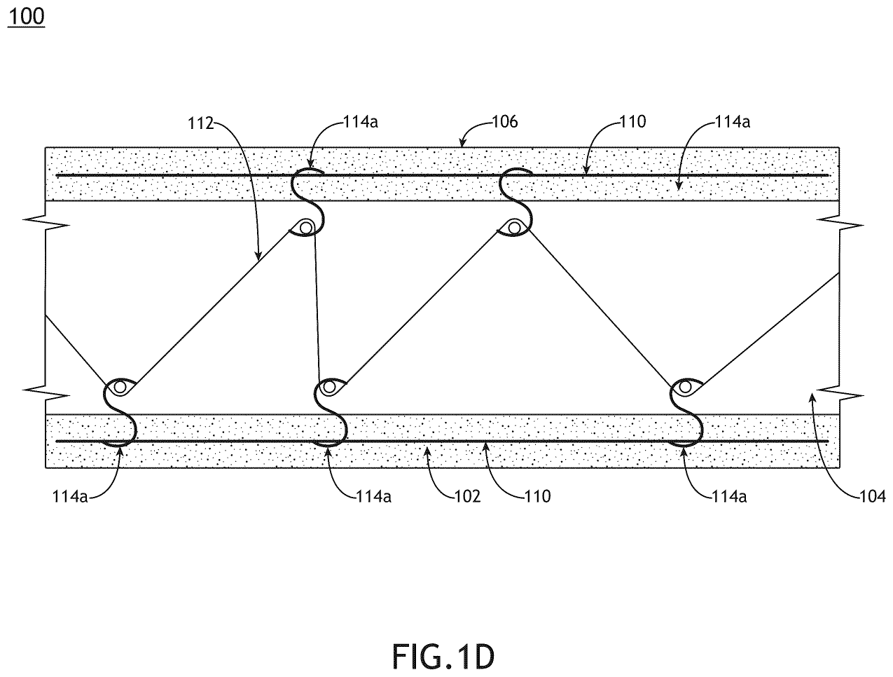

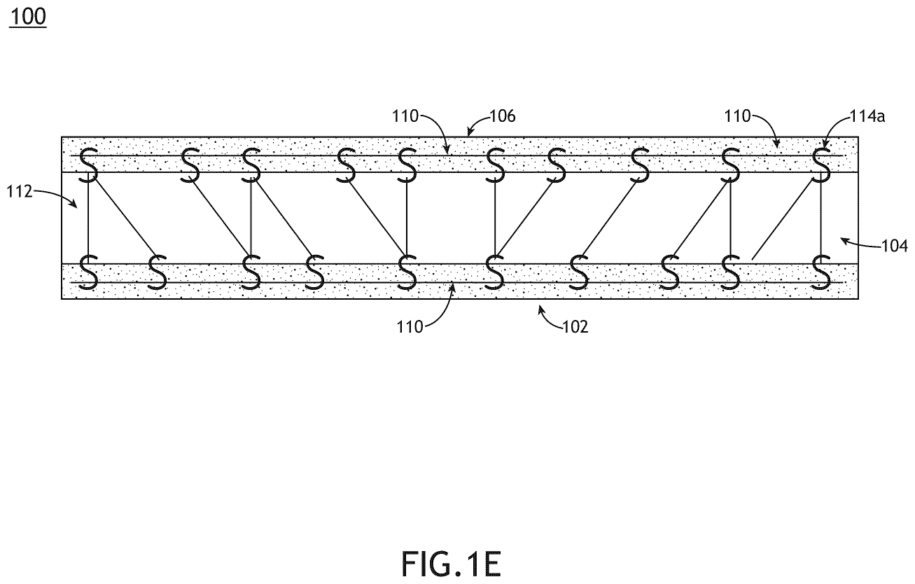

FIGS. 1A-11, depict a composite panel 100, in accordance with one or more embodiments of the present disclosure. The composite panel 100 may be structural or non-structural. The composite panel 100 may include a bottom concrete layer 102, middle insulation layer 104, top concrete layer 106, and/or trusses 108. The bottom concrete layer 102, the middle insulation layer 104, the top concrete layer 106, and/or the trusses 108 may extend along the longitudinal span of the composite panel 100.

The composite panel 100 may be a three-layer composite panel. For example, the composite panel 100 may include the bottom concrete layer 102, middle insulation layer 104, and top concrete layer 106. The bottom concrete layer 102, middle insulation layer 104, and top concrete layer 106 may be collectively referred to as the layers. The layers may be described in the order that the layers may be manufactured. The middle insulation layer 104 may be disposed between the bottom concrete layer 102 and the top concrete layer 106.

It is contemplated that the composite panel 100 may be used in several orientations, such as, but not limited to, a horizontal orientation, a vertical orientation, or an orientation therebetween. The bottom concrete layer 102 and top concrete layer 106 may also be outside concrete layers and/or wythes. The composite panel 100 may be a composite member, a composite slab panel, a composite wall panel, a composite roof slab, slab-on-grade, suspended slabs, or any other flat element. The bottom concrete layer 102 and top concrete layer 106 may be used as the outside and inside of the composite wall panel, respectively, but could also be used as the inside and outside of the composite wall panel, respectively. The bottom concrete layer 102 and top concrete layer 106 of a composite slab panel or composite roof panel may be used as the bottom of the composite slab panel or composite roof panel, respectively.

The bottom concrete layer 102 and top concrete layer 106 may be made of a concrete material. The concrete material may include a zero- or low-slump concrete. The concrete material may be able to be slip formed or extruded. The concrete material may include a composition of cements, water, aggregates, admixtures, and the like. The composition of the concrete material may be based on a mix design and is not intended to be limiting. Technologies to reduce a carbon footprint of the concrete material may be employed, such as, but not limited to, recycled supplementary cementitious materials or other carbon capturing/reduction methods. The concrete material may include other properties that increases the sustainability of the concrete material, such as, but not limited to, the inclusion of waste products (fly ash, slag, etc.) or other carbon capturing methods to increase sustainability.

The bottom surface of the bottom concrete layer 102 and the top surface of the top concrete layer 106 may be flat. For example, the bottom surface of the bottom concrete layer 102 and the top surface of the top concrete layer 106 may be planar with a smooth or even surface. The planar surfaces may be oriented horizontal, angled, or vertical relative to ground, depending upon the orientation of the composite panel 100.

The top surface of the bottom concrete layer 102 and the bottom surface of the top concrete layer 106 may include ridge portions 116 and/or ditch portions 118. The ridge portions 116 and/or the ditch portions 118 may extend along the longitudinal span (e.g., a length) of the composite panel 100. The ditch portions 118 may connect between the ridge portions 116. For example, the ditch portions 118 may span between of the ridge portions 116 along the width.

The bottom concrete layer 102 and the top concrete layer 106 may be thicker along the ridge portions 116 than along the ditch portions 118. The bottom concrete layer 102 may include bottom thicknesses defined by the thickness between the ridge portions 116 and/or the ditch portions 118 and the bottom surface of the bottom concrete layer 102. For example, a first bottom thickness of the bottom concrete layer 102 between the ridge portions 116 and the bottom surface of the bottom concrete layer 102 may be more than a second bottom thickness of the bottom concrete layer 102 between the ditch portions 118 and the bottom surface of the bottom concrete layer 102. The top concrete layer 106 may include top thicknesses defined by the thickness between the ridge portions 116 and/or the ditch portions 118 and the top surface of the top concrete layer 106. A first top thickness of the top concrete layer 106 between the ridge portions 116 and the top surface of the top concrete layer 106 may be more than a second top thickness of the top concrete layer 106 between the ditch portions 118 and the top surface of the bottom concrete layer 102.

The bottom thicknesses of the bottom concrete layer 102 and the top thicknesses of the top concrete layer 106 may be a same thickness or different thicknesses. It is further contemplated that the bottom thicknesses and/or top thicknesses may be thicker and/or thinner. For example, the bottom thicknesses and/or top thicknesses may be thicker and/or thinner to accommodate embedded items, create camber in the composite panel 100, and the like.

The bottom concrete layer 102 and top concrete layer 106 may include a linear array of the ridge portions 116 and/or the ditch portions 118 along the width of the composite panel 100. The ridge portions 116 of the bottom concrete layer 102 may align with the ridge portions 116 of the top concrete layer 106. Similarly, the ditch portions 118 of the bottom concrete layer 102 may align with the ditch portions 118 of the top concrete layer 106.

The ditch portions 118 may include a select shape. For example, the ditch portions may include a flat shape, a round shape (e.g., concave), a polygon shape (e.g., isosceles trapezoid), or a combination of arc shapes and polygon shapes. The ditch portions 118 of the bottom concrete layer 102 may or may not be the same shape as the ditch portions 118 of the top concrete layer 106.

The middle insulation layer 104 may be disposed between the bottom concrete layer 102 and the top concrete layer 106. For example, the middle insulation layer 104 may be disposed between the ridge portions 116 and/or the ditch portions 118 of the bottom concrete layer 102 and the ridge portions 116 and/or the ditch portions 118 of the top concrete layer 106. The middle insulation layer 104 may fill the space between the bottom concrete layer 102 and top concrete layer 106. For example, the middle insulation layer 104 may abut the top surface of the bottom concrete layer 102 and the bottom surface of the top concrete layer 106. For instance, the middle insulation layer 104 may abut the ridge portions 116 and the ditch portions 118 of the bottom concrete layer 102 and top concrete layer 106.

A density of the middle insulation layer 104 may be less than densities of the bottom concrete layer 102 and/or the top concrete layer 106. In this regard, the middle insulation layer 104 may serve to reduce a weight of the composite panel 100.

The middle insulation layer 104 may be made of an insulation material. The insulation material may be slip formed (i.e., flowable during forming), but not slump or sag while curing. The insulation material may include a hemp-based insulation material, an aerated zero-slump concrete, a cellular concrete, a pervious concrete, a Styrofoam aggregate concrete, or the like. For example, the hemp-based insulation material may include hempcrete. The hempcrete of the middle insulation layer 104 may be zero-slump hempcrete. The hempcrete may be beneficial to reduce carbon emissions produced when manufacturing the composite panel 100. For example, the hempcrete may cause the composite panel 100 to be carbon neutral and/or carbon negative.

The composition of the insulation material may include granular materials with insulating properties bonded together with a cementitious or polymer binder material formed and compressed in the extrusion process. The insulation material may be organic or non-organic. The insulation material may be a waste by-product or a virgin material. The granular materials may include, but are not limited to, hemp hurds, rice husks, hay straw, waste or virgin foam pieces, foam beads (e.g., polystyrene foam beams), or other similar materials. In embodiments, the granular materials may include hemp hurds (also called shiv or shive) which is the woody part of the hemp plant. The hemp hurds may not easily decompose in mineral binder, may have a good compressive strength, and may be used in various iterations of hempcrete. The cementitious material may include Portland cement, calcium sulfoaluminate (CSA), fly ash, lime, gypsum, geopolymer, alkali-activated polymer, acid activated polymer or a combination of these and other materials. The cementitious material may be cured to bind the granular materials (e.g., hemp hurds). The composition of the insulation material may be based on a mix design and is not intended to be limiting. The insulation material may include a limited use of Portland cement along with the possibility of the use of organic material (like hemp), may allow the potential for carbon reduction, carbon neutral, or even carbon negative members. The insulative material may dictate the amount of carbon reduction. The composite panels 100 may be considered organic composite panels when the insulation material includes the organic material.

The middle insulation layer 104 may insulate the bottom concrete layer 102 from the top concrete layer 106. In this regard, the composite panel 100 may be an insulated panel. For example, the middle insulation layer 104 may insulate the bottom concrete layer 102 from transferring heat, sound, and the like to the top concrete layer 106. The insulation material may define the R-value of the middle insulation layer 104. The middle insulation layer 104 may include a select R-value. For example, the insulation material may include an R-value of between 0.67 and 1.2 per cm, where the insulation material is hempcrete. The R-value of the middle insulation layer 104 may be higher than the R-value of the concrete material. In this regard, the middle insulation layer 104 may insulate the bottom concrete layer 102 from the top concrete layer 106. The R-value of the middle insulation layer 104 may be more than the R-values of the bottom concrete layer 102 and/or the top concrete layer 106.

The insulation material may define the compressive strength of the middle insulation layer 104. The middle insulation layer 104 may have a select compressive strength. For example, the middle insulation layer 104 may have a compressive strength of 0.069 MPa (e.g., 10 psi) or greater. For example, the middle insulation layer 104 may have a compressive strength of between 0.069 and 25 MPa. The compressive strength of the middle insulation layer 104 may be less than the compressive strengths of the bottom concrete layer 102 and/or the top concrete layer 106. The middle insulation layer 104 may reduce a weight of the composite panel 100, as compared to using concrete materials between the bottom concrete layer 102 and the top concrete layer 106. However, reducing the weight of the composite panel 100 may come at the cost of the reduced compressive strength. One challenge with the use of hempcrete or other insulation materials is the reduced compressive strength of the composite panel 100.

The middle insulation layer 104 may be disposed between the bottom concrete layer 102 and the top concrete layer 106 along the longitudinal span of and across the width of the composite panel 100. Thus, the middle insulation layer 104 may carry shear and delamination forces between the bottom concrete layer 102 and the top concrete layer 106. The shear forces may be along the longitudinal span of the composite panel 100. The delamination forces may be across the width of the composite panel 100. The compressive strength of the middle insulation layer 104 being less than the compressive strengths of the bottom concrete layer 102 and/or the top concrete layer 106 may raise challenges with transferring the shear and delamination forces through the middle insulation layer 104 without additional support.

In embodiments, the composite panel 100 may include the trusses 108. For example, the composite panel 100 may include a plurality of the trusses 108. The trusses 108 may be in a linear array along the width of the composite panel 100. The linear array may include consistent spacing between adjacent of the trusses 108 along the width.

The trusses 108 may be formed of one or more truss members. For example, the trusses 108 may include prestress strands 110, truss webs 112, and/or joints 114. The truss members of the trusses 108 may be any size, strength, and material that meets the structural, design or code requirements for the composite panel 100.

The trusses 108 may provide a composite behavior between the bottom concrete layer 102 and the top concrete layer 106. The trusses 108 may transfer forces bidirectionally between the bottom concrete layer 102 and the top concrete layer 106 through tensile force (e.g., axial and/or shear forces). The actions between the bottom concrete layer 102 and the top concrete layer 106 that are resisted may include shear and delamination forces. The trusses 108 may transfer the shear and delamination forces between the bottom concrete layer 102 and the top concrete layer 106, thereby remedying the relatively low compressive strength associated with the middle insulation layer 104. The trusses 108 may also transfer other forces, but the shear and delamination forces may be the primary loads that are carried by the trusses 108. In embodiments, the trusses 108 provide little or no compressive strength between the bottom concrete layer 102 and the top concrete layer 106. For example, the truss webs 112 may be made of wires which provide no compressive strength between the bottom concrete layer 102 and the top concrete layer 106. Instead, the compression strength between the bottom concrete layer 102 and the top concrete layer 106 may be derived from the middle insulation layer 104. For example, compressive forces may be transferred between the bottom concrete layer 102 and the top concrete layer 106 via the middle insulation layer 104. The middle insulation layer 104 may transfer the compressive forces and the trusses 108 may transfer the shear and delamination forces. Thus, the bottom concrete layer 102, middle insulation layer 104, and top concrete layer 106 may be made to act together (compositely) via the trusses 108.

The prestress strands 110 may extend along the longitudinal span of the composite panel 100. The prestress strands 110 may be disposed within the bottom concrete layer 102 and the top concrete layer 106. The composite panel 100 may include a matching number of the prestress strands 110 in the bottom concrete layer 102 and in the top concrete layer 106. For example, the trusses 108 may include half of the prestress strands 110 disposed within the bottom concrete layer 102 and half disposed within the top concrete layer 106. The prestress strands 110 may be disposed within the bottom concrete layer 102 and the top concrete layer 106 and extend along the longitudinal span of the composite panel 100. Each of the trusses 108 may include a pair of the prestress strands 110. One of the pair of prestress strands 110 may be in the bottom concrete layer 102 and another of the pair of prestress strands 110 may be in the top concrete layer 106.

The prestress strands 110 may be chords of the trusses 108. The prestress strands 110 in the bottom concrete layer 102 and the top concrete layer 106 may define a bottom chord and a top chord, respectively, of the truss webs 112. The prestress strands 110 in the bottom concrete layer 102 and the top concrete layer 106 may be horizontal members that define the lower edge and upper edge, respectively, of the truss webs 112.

The prestress strands 110 may include a select material, such as, but not limited to, prestressed concrete steel strand (PC strand). The prestress strands 110 may include a strand diameter. For example, the prestress strands 110 may include a strand diameter of 9.5 mm (e.g., ⅜″), 12.7 mm (e.g., ½″), 15.2 mm (e.g., 0.6″), smaller than 9.5 mm, or larger than 15.2 mm. The prestress strands 110 may include a wire structure, such as, but not limited to a 1×2, 1×3, 1×7, and the like.

The prestress strands 110 may tension the bottom concrete layer 102 and the top concrete layer 106 along the longitudinal span of the composite panel 100. The tension of the bottom concrete layer 102 and the top concrete layer 106 along the longitudinal span of the composite panel 100 may improve a strength of the bottom concrete layer 102 and the top concrete layer 106 in flexure. In this regard, the prestress strands 110 may be a main component for the reinforcement of the composite panel 100. In embodiments, the composite panel 100 may include camber. The camber may keep the composite panel 100 from sagging due to dead load (e.g., the weight of the composite panel 100 and any additional concrete topping added to level the composite panel 100). The camber may be built into the composite panel 100. The camber may be built into the composite panel 100 by increasing a diameter of the prestress strands 110 in the bottom concrete layer 102, thereby imparting a larger precompression force in the bottom concrete layer 102 than the top concrete layer 106. The camber may also be built into the composite panel 100 by tensioning the prestress strands 110 in the bottom concrete layer 102 more than the prestress strands 110 in the top concrete layer 106.

The truss webs 112 may extend along the longitudinal span of the composite panel 100. The truss webs 112 may be disposed in the middle insulation layer 104.

In embodiments, the truss webs 112 may be made of one or more members, such as, but not limited to, a solid member, a wire member (e.g., a braided wire), or the like. The truss webs 112 may be made of a material, as, but not limited to, solid steel, braided steel, hollow steel, galvanized steel, stainless steel, or other metal, fiber infused resin (e.g., glass fiber, carbon fiber, basalt fiber and resin), nylon, polypropylene and other synthetic or natural fibers woven or spun into a rope or cord. The truss webs 112 may include a select diameter. The diameter of the truss webs 112 may be 1 mm, 1.58 mm (e.g., 1/16″), 2 mm, 3 mm, 3.18 mm (e.g., ⅛″), 4.76 mm (e.g., 3/16″), 6.35 mm (e.g., ¼″), a diameter therebetween, or a larger diameter.

The truss webs 112 may be tension wires. The tensions wires may carry tension forces but may not carry compressive forces between the bottom concrete layer 102 and the top concrete layer 106.

The truss webs 112 may be set at one or more angles (theta). The angles of the truss webs 112 may vary depending on the truss design, dimensions, and loads. The truss webs 112 may take the form of diagonal and/or vertical webs of various angles. The vertical webs may include a vertical angle which is normal to the plane of the bottom concrete layer 102 and the top concrete layer 106. The vertical webs may be used throughout the trusses 108 to prevent delamination. The vertical webs may be important to prevent delamination because the interface between the concrete layers and the middle insulation layer 104 may have minimal or no bond. The vertical webs, if of sufficient size, may transfer shear forces through bending and shear deformation as in a Vierendeel style truss.

In embodiments, the trusses 108 may include a truss design. The arrangement of the truss webs 112 may define the truss design. The truss design may include, but is not limited to, a Warren truss, a Pratt truss, a Vierendeel truss, a Mansard truss, or the like. It is contemplated that the truss webs 112 may include any suitable truss design. In embodiments, the truss design may be selected based on the orientation of the composite panel 100 when in use. For example, FIGS. 1B-1E depict examples of the truss designs.

In embodiments, the trusses 108 may be “closed web” trusses. For example, the space between the truss webs 112 may be filled with the insulation material of the middle insulation layer 104. The insulation material of the middle insulation layer 104 may thus close the spaces between the truss webs 112.

The joints 114 may join the truss webs 112 to the prestress strands 110. The joints 114 may be disposed in the bottom concrete layer 102 and/or the top concrete layer 106. For example, the joints 114 which join the truss webs 112 to the prestress strands 110 of the bottom concrete layer 102 may be disposed in the bottom concrete layer 102 and optionally in the middle insulation layer 104. By way of another example, the joints 114 which join the truss webs 112 to the prestress strands 110 of the top concrete layer 106 may be disposed in the top concrete layer 106 and optionally in the middle insulation layer 104.

The truss webs 112 and joints 114 may cooperatively span between and connect to the prestress strands 110 in the bottom concrete layer 102 and the top concrete layer 106, through the middle insulation layer 104. The truss webs 112 and joints 114 may be layer connectors between the bottom concrete layer 102 and the top concrete layer 106. The truss webs 112 and joints 114 may be members which spans between and connects the prestress strands 110 in the bottom concrete layer 102 and the prestress strands 110 in the top concrete layer 106. The truss webs 112 and joints 114 may transfer the tension loads between the prestress strands 110 in the bottom concrete layer 102 and the top concrete layer 106. The tension loads may be induced by environmental or dead loads imposed on the composite panel 100.

Either the truss webs 112 or the joints 114 may extend through the bottom surface of the bottom concrete layer 102 and the top surface of the top concrete layer 106. The truss webs 112 or the joints 114 may join the concrete layers (i.e., the bottom concrete layer 102 and/or the top concrete layer 106) to the middle insulation layer 104 by extending through the bottom surface of the bottom concrete layer 102 and the top surface of the top concrete layer 106 into the middle insulation layer 104.

In embodiments, the joints 114 may extend through the bottom surface of the bottom concrete layer 102 and the top surface of the top concrete layer 106 into the middle insulation layer 104. The truss webs 112 may be disposed in the middle insulation layer 104 and may not extend into the bottom concrete layer 102 and/or the top concrete layer 106. The truss webs 112 may be coupled to the joints 114 in the middle insulation layer 104. In this regard, the trusses 108 may be considered to include long joints with short truss webs. The joints 114 may be made from a non-thermally conductive materially such that extending the joints 114 through the concrete layers into the middle insulation layer 104 may minimize the thermal transfer between the bottom concrete layer 102 and the top concrete layer 106. For example, the thermal conductivity of the joints 114 may be less than the thermal conductivity of the truss webs 112.

In embodiments, the truss webs 112 may extend from the middle insulation layer 104 through the bottom surface of the bottom concrete layer 102 and the top surface of the top concrete layer 106. The joints 114 may be disposed in the bottom concrete layer 102 and the top concrete layer 106 and may not extend into the middle insulation layer 104. The truss webs 112 may be coupled to the joints 114 in the bottom concrete layer 102 and the top concrete layer 106. In this regard, the trusses 108 may be considered to include short joints with long truss webs. The joints 114 may not extend into the middle insulation layer 104 if the thermal properties of the composite panel 100 is not a priority. The short joints with long truss webs may increase structural design properties and may be used in floor or structural members where strength is the priority. For example, the thermal conductivity of the truss webs 112 may be less than the thermal conductivity of the joints 114.

The truss webs 112 and/or joints 114 may be made of a material, such as, but not limited to, steel, carbon fiber, polymer, fiber reinforced polymer, or the like. The steel may include plain steel, stainless steel, galvanized steel, carbon steel, stainless steel, or the like. The polymer may include resins, vinyl ester, polyester, nylon, polypropylene, or the like. The fiber may include glass fiber, carbon fiber, organic fiber, steel fiber, basalt fiber, hemp fiber, organic fiber, non-organic fibers, synthetic fiber, natural fiber, or the like. In embodiments, the joints 114 may be made from a combination of materials, such as steel hooks surrounded by fiber resins, insulative or protective coating on the hook material. In embodiments, the joints 114 may be made from composite materials, such as glass fiber and resins, and the truss webs 112 may be made from a steel wire. The materials of the truss webs 112 and/or joints 114 may be selected such that the trusses 108 may include low thermal conductivity. The trusses 108 may include low thermal conductivity such that the composite panel 100 may be used for insulation purposes. The low thermal conductivity for insulation purposes may not be necessary if the composite panel 100 is not required to have insulation properties. In embodiments, both the truss webs 112 and/or joints 114 may be steel (e.g., galvanized steel, stainless steel, and the like). Where both the truss webs 112 and/or joints 114 are steel, the trusses 108 may include a relatively high thermal conductivity as heat may transfer between the bottom concrete layer 102 and the top concrete layer 106 through the middle insulation layer 104 via the trusses 108.

The truss webs 112 and/or joints 114 may be formed by bending, casting, stamping, forging, molding (e.g., injection, compression, or other molding techniques), or another suitable manufacturing process.

The truss webs 112 may be continuous truss webs 112a or segmented truss webs 112b.

In embodiments, the truss webs 112 may be a continuous truss webs 112a. The continuous truss webs 112a may extend along the longitudinal span of the composite panel 100 without a break. The continuous truss webs 112a may be considered continuous by being formed form a single member which does not include any breaks along the longitudinal span. The continuous truss webs 112a may include a continuous length of wire along the longitudinal span.

In embodiments, the truss webs 112 may be segmented truss webs 112b. The segmented truss webs 112b may include segments 113. Individual of the segments 113 do not extend along the longitudinal span of the composite panel 100. However, multiple of the segments 113 may connect to form the segmented truss webs 112b and cooperatively extend along the longitudinal span of the composite panel 100.

The segments 113 may connect directly between two of the joints 114 which are immediately adjacent. The segments 113 may connect from at least one of the joints 114 in the bottom concrete layer 102 to at least one of the joints 114 in the top concrete layer 106. The segments 113 may connect between two of the joints 114 which are immediately adjacent (e.g., one in the bottom concrete layer 102 and one in the top concrete layer 106). The segments 113 may also connect between three or more of joints 114 which are immediately adjacent. The segments 113 may also connect between three or more of joints before terminating and locking to avoid slippage. The segments 113 may connect to first, second, and third joints, where the first and third joints are on opposing sides to the second joint and where the second joint is disposed between the first and third joints.

The segmented truss webs 112b may include one or more loops for connecting to the joints 114. The segmented truss webs 112b may include open-looped segmented truss webs 112b-1 where the segments 113 are open-looped segments 113-1 and/or double-looped segmented truss webs 112b-2 where the segments 113 are double-looped segments 113-2.

In embodiments, the segmented truss webs 112b are open-looped segmented truss webs 112b-1 including the open-looped segments 113-1. The open-looped segments 113-1 may be formed from a wire which is welded, swaged, clamped, crimped, or the like. The open-looped segments 113-1 may be joined to at least two of the joints 114. For example, the open-looped segments 113-1 may be joined to at least one of a bottom of the joints 114 which is joined to the prestress strands 110 in the bottom concrete layer 102 and at least one of a top of the joints 114 which is joined to the prestress strands 110 in the top concrete layer 106. In some instances, the open-looped segments 113-1 may be joined to three or more of the joints 114. For example, the open-looped segments 113-1 may be joined to two of the bottom of the joints 114 which is joined to the prestress strands 110 in the bottom concrete layer 102 and one of the top of the joints 114 which is joined to the prestress strands 110 in the top concrete layer 106. By way of another example, the open-looped segments 113-1 may be joined to one of the bottom of the joints 114 which is joined to the prestress strands 110 in the bottom concrete layer 102 and two of the top of the joints 114 which is joined to the prestress strands 110 in the top concrete layer 106.

In embodiments, the segmented truss webs 112b are double-looped segmented truss webs 112b-2 include the double-looped segments 113-2. The double-looped segments 113-2 may include a shank connecting between opposing loop ends (e.g., eyelets). The double-looped segments 113-2 may be formed from a wire which may be welded, clamped, crimped, twisting the wires about itself with one or more wraps, a simple bend or hook, or the like to form the opposing loop ends. The double-looped segments 113-2 may be joined to two of the joints 114. For example, the double-looped segments 113-2 may be joined to one of the bottom of the joints 114 which is joined to the prestress strands 110 in the bottom concrete layer 102 and one of the top of the joints 114 which is joined to the prestress strands 110 in the top concrete layer 106.

The joints 114 may include any suitable design for joining the truss webs 112 to the prestress strands 110. For example, the joints 114 may be double-ended hook joints 114a, lock joints 114b, and the like.

In embodiments, the joints 114 may be double-ended hook joints 114a. For example, the double-ended hook joints 114a may include a first hook end and a second hook end. The first hook end may join to the prestress strands 110 and the second hook end may join to the truss webs 112. It is contemplated that the double-ended hook joints 114a may include ε-shaped hooks (i.e., where the first and second hook ends open in a same direction) or S-shaped hooks (i.e., where the first and second hook ends open in opposing directions).

It is contemplated that the double-ended hook joints 114a may or may not lock to the prestress strands 110 and/or the truss webs 112. It is contemplated that one disadvantage with the double-ended hook joints 114a is that the prestress strands 110 and/or the truss webs 112 may slip past the hook ends of the joints 114. For example, the prestress strands 110 and/or the truss webs 112 may slip past the hook ends of the joints 114 where the truss webs 112 are continuous lengths of wire. If the prestress strands 110 and/or the truss webs 112 slips past the joints 114 then the shear load transfer by the trusses 108 may be reduced.

In embodiments, the lock joints 114b may lock to the prestress strands 110 and/or the truss webs 112. Locking the joints 114 to the prestress strands 110 and/or the truss webs 112 may prevent the prestress strands 110 and/or the truss webs 112, respectively, from slipping past the lock joints 114b. The lock joints 114b may reduce or eliminate slippage of the prestress strands 110 and/or the truss webs 112. The lock joints 114b may be used for any of the joints 114 to prevent slippage. In embodiments, the lock joints 114b may be used at each of the joints 114. Although the lock joints 114b have been described as used at each of the joints 114, this is not intended as a limitation of the present disclosure. In embodiments, the lock joints 114b disposed at the ends of the composite panels 100. In embodiments, the lock joints 114b may be used at locations with higher design loads.

The lock joints 114b may lock to the prestress strands 110 and/or the truss webs 112 by a variety of methods. The lock joints 114b may lock to the truss webs 112 by twisting the truss webs 112 around the joints 114, passing the truss webs 112 over and under hub-type members of the joints 114, cam locks, twisting of the hook, knots, crimp ring, welding or a combination of these methods could be used to accomplish the goal of minimal slippage. The lock joints 114b may include truss lock joints 114b-1, hanger lock joints 114b-2, double-ended hook lock joints 114b-3, and the like.

In embodiments, the ridge portions 116 and the trusses 108 may be aligned. For example, the prestress strands 110 within the bottom concrete layer 102 may be aligned with and disposed below the ridge portions 116 of the bottom concrete layer 102. The prestress strands 110 within the top concrete layer 106 may be aligned with and disposed above the ridge portions 116 of the top concrete layer 106. The truss webs 112 may be aligned with and disposed between the ridge portions 116. The joints 114 may be aligned with the ridge portions 116. Either the truss webs 112 or the joints 114 may extend through the ridge portions 116.

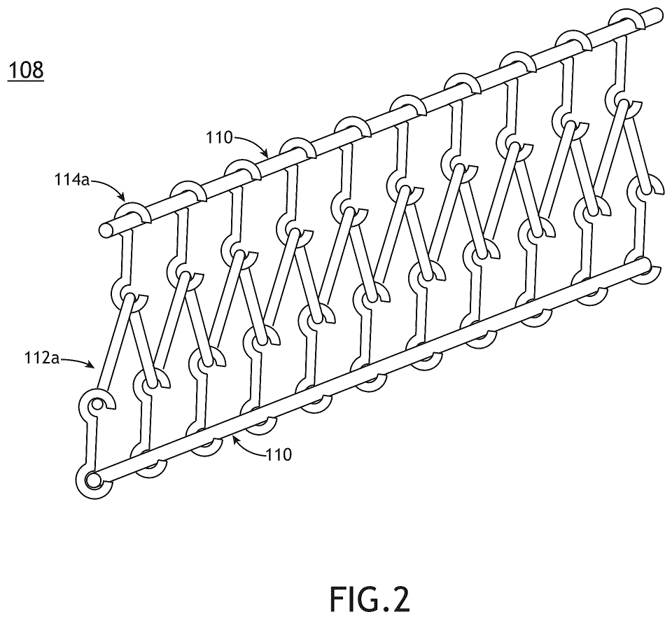

FIG. 2 depicts a perspective view of the trusses 108 with the continuous truss webs 112a and double-ended hook joints 114a, in accordance with one or more embodiments of the present disclosure.

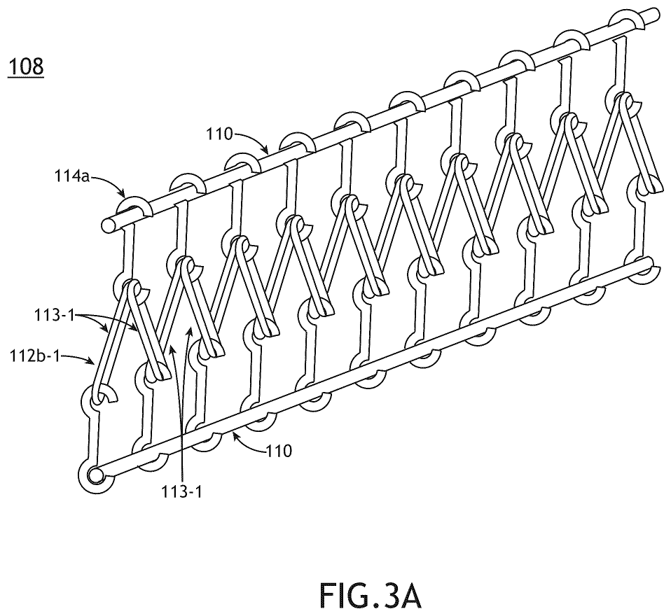

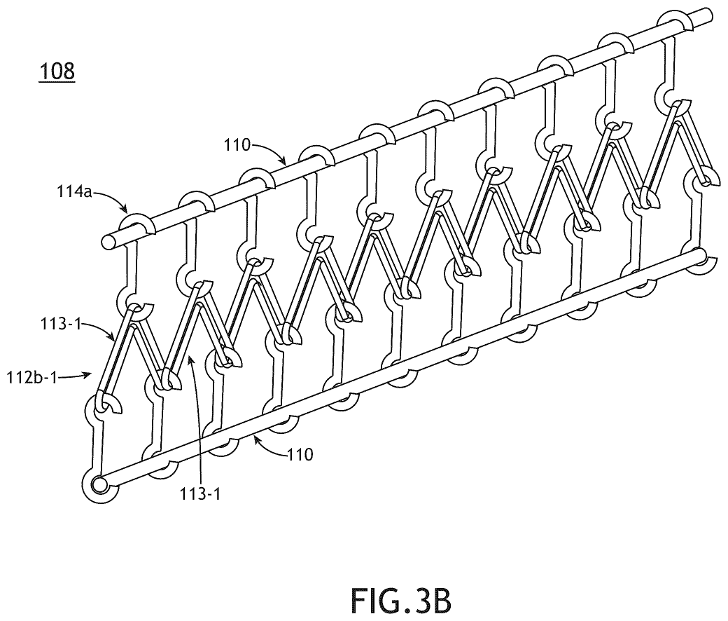

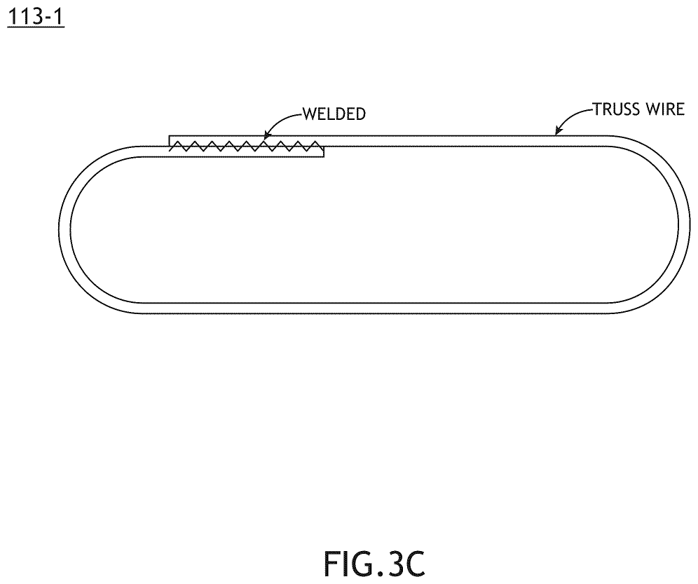

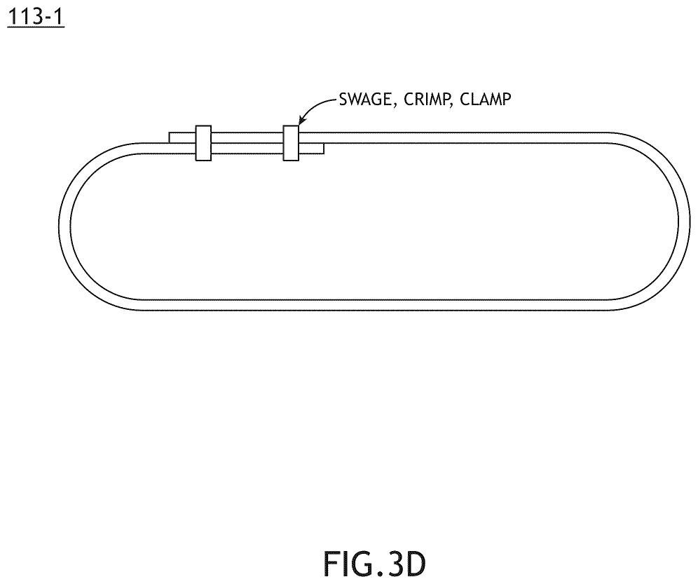

FIGS. 3A-3D depict the trusses 108 with the open-looped segmented truss webs 112b-1 and the double-ended hook joints 114a, in accordance with one or more embodiments of the present disclosure. In the example of FIG. 3A, the open-looped segments 113-1 of the open-looped segmented truss webs 112b-1 are joined to two of the double-ended hook joints 114a. In the example of FIG. 3B, the open-looped segments 113-1 of the open-looped segmented truss webs 112b-1 are joined to three of the double-ended hook joints 114a.

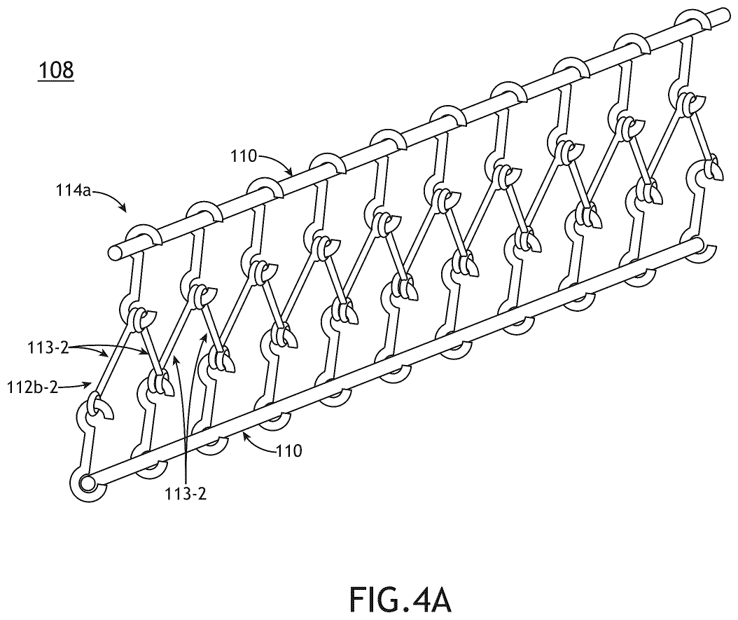

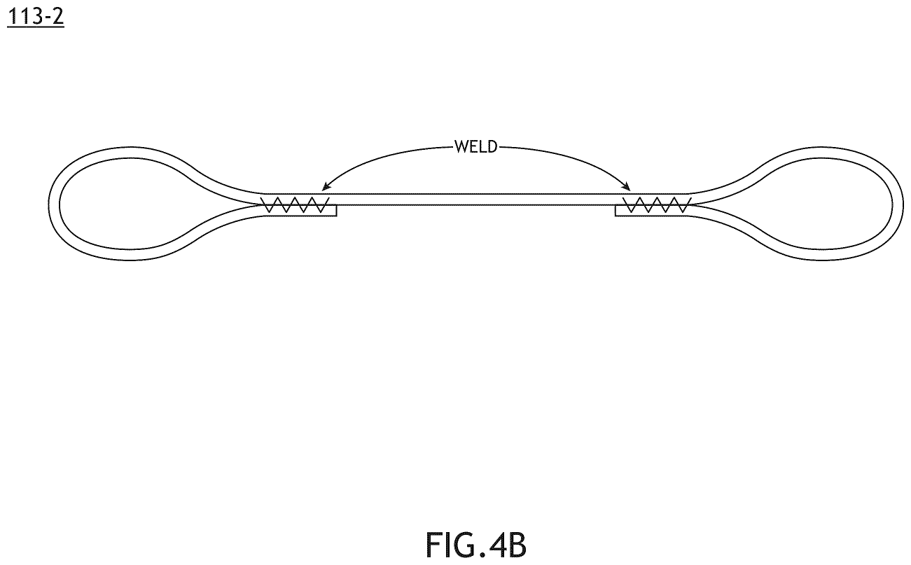

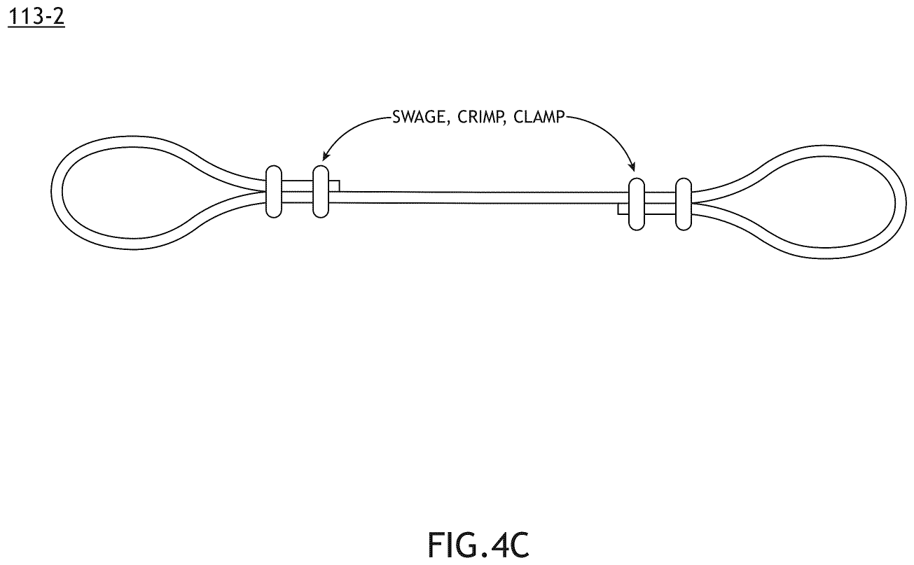

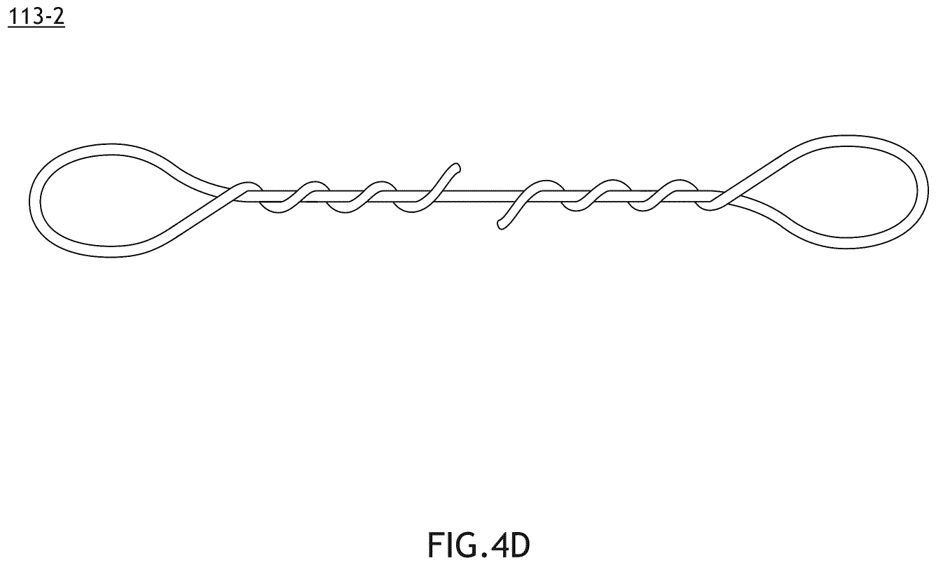

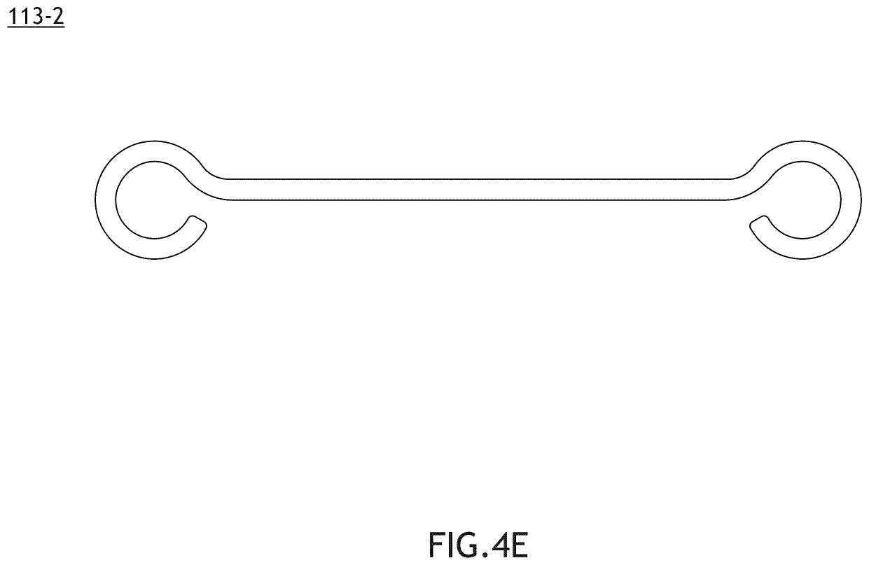

FIGS. 4A-4E depict the double-looped segmented truss webs 112b-2 with the double-ended hook joints 114a, in accordance with one or more embodiments of the present disclosure. In the example of FIG. 4A, the double-looped segments 113-2 of the double-looped segmented truss webs 112b-2 are joined to two of the double-ended hook joints 114a.

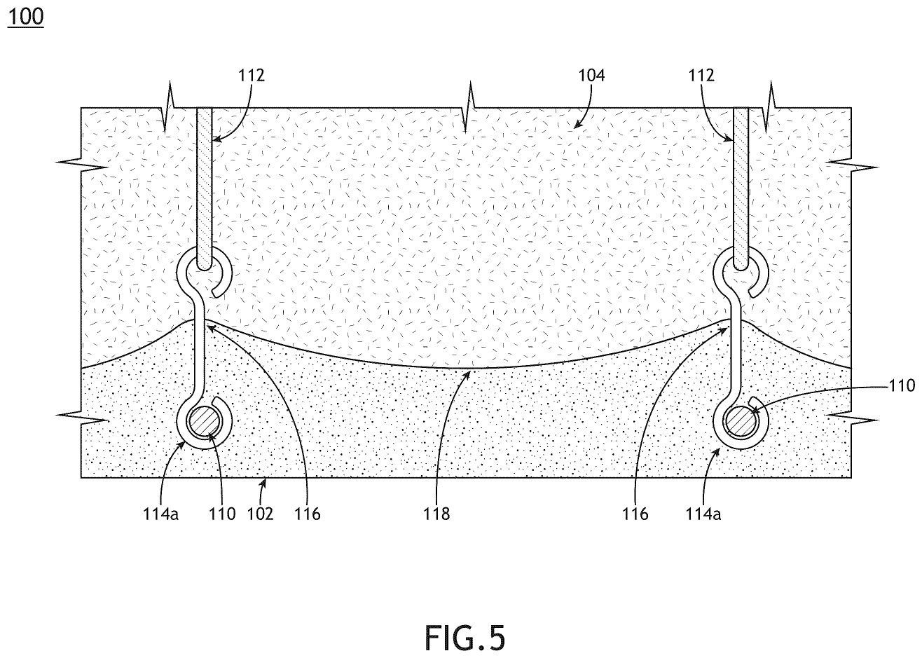

FIG. 5 depicts a partial cross-section along a width of the composite panels 100, in accordance with one or more embodiments of the present disclosure. In this configuration the ditch portions 118 of the bottom concrete layer 102 are round and the joints 114 may be the double-ended hook joints 114a with a ε-shape. The joints 114 may extend through the concrete layers into the middle insulation layer 104 and the truss webs 112 may be disposed in the middle insulation layer 104 and may not extend into the concrete layers.

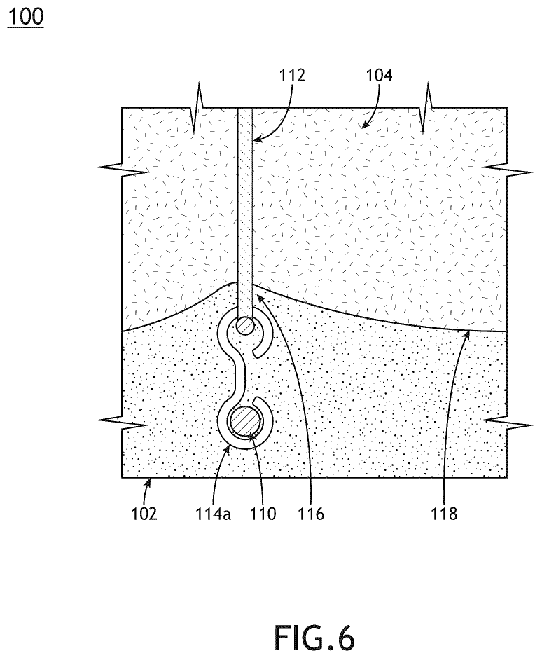

FIG. 6 depicts a partial cross-section along a width of the composite panels 100, in accordance with one or more embodiments of the present disclosure. In this configuration the ditch portions 118 of the bottom concrete layer 102 may be round and the joints 114 may be the double-ended hook joints 114a with a ε-shape. In this configuration, the joints 114 may be disposed in the concrete layers and may not extend into the middle insulation layer 104. The truss webs 112 may be disposed in the middle insulation layer 104 and may extend into the concrete layers.

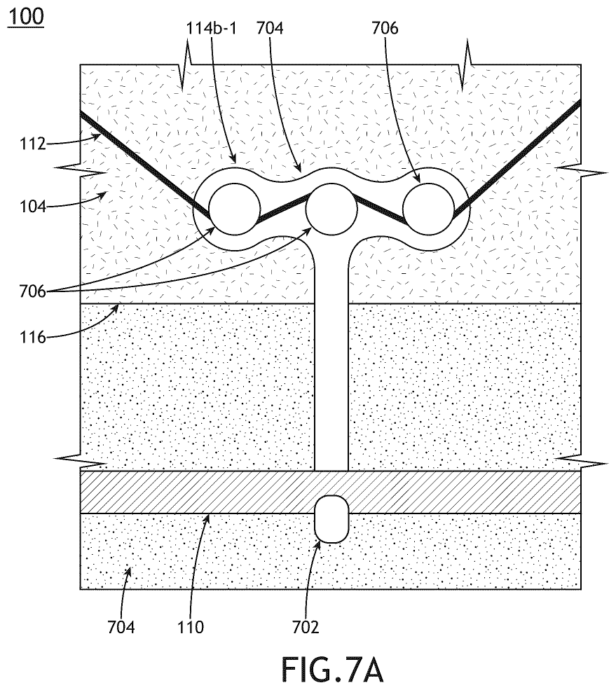

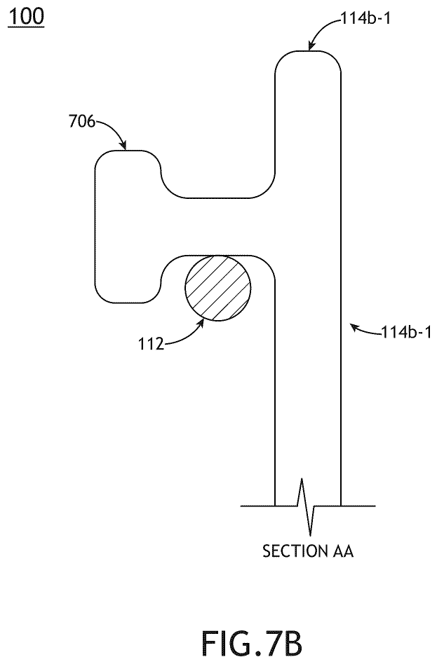

FIGS. 7A-7B depict the truss lock joints 114b-1, in accordance with one or more embodiments of the present disclosure. The truss lock joints 114b-1 extend into the middle insulation layer 104. In embodiments, the truss lock joints 114b-1 may include hook end 702 and a hub end 704. The hook end 702 may couple to the prestress strands 110. The hub end 704 may couple to the truss webs 112. For example, the hub end 704 may include hub-type members 706. The truss webs 112 may be passed over and under hub-type members 706 thereby cinching the truss webs 112 to the hub end 704. Thus, the truss lock joints 114b-1 may be locked to the truss webs 112.

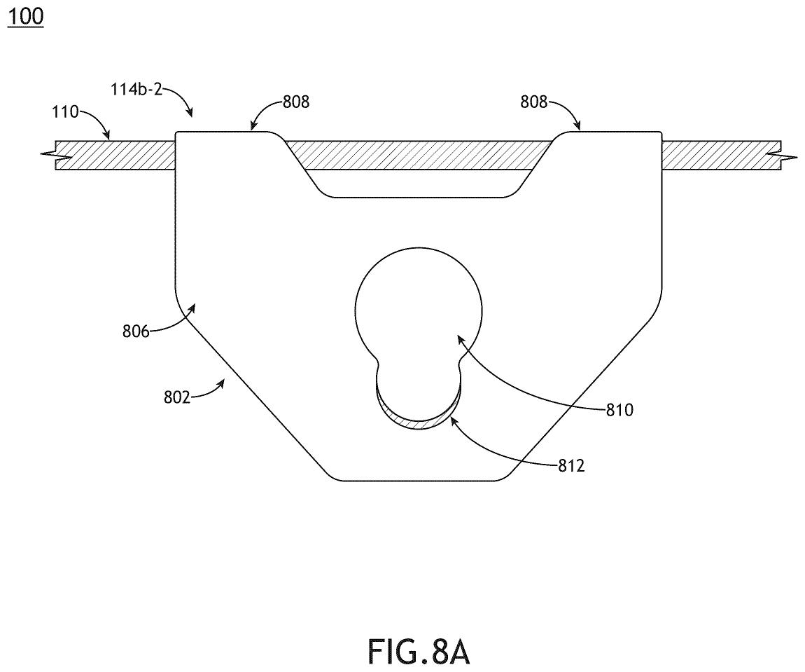

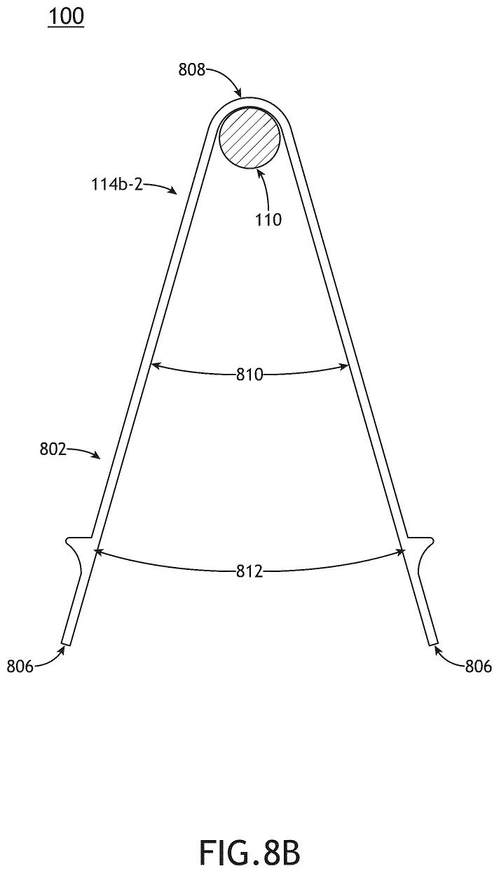

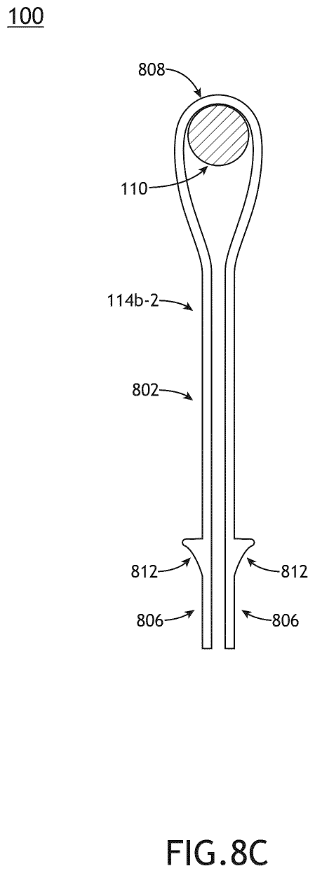

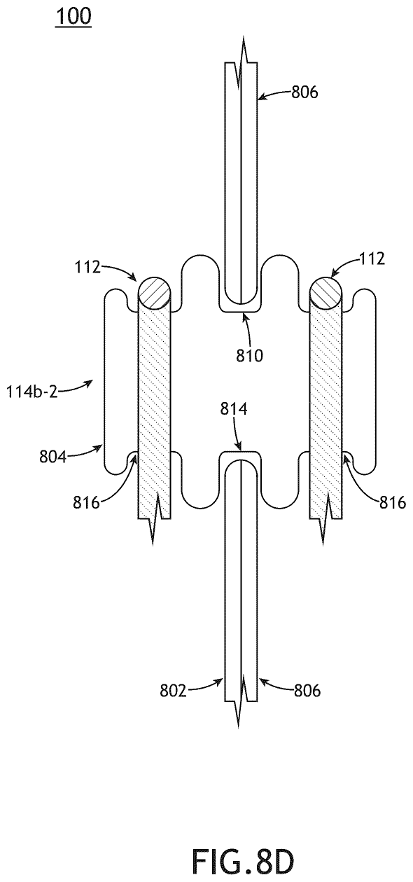

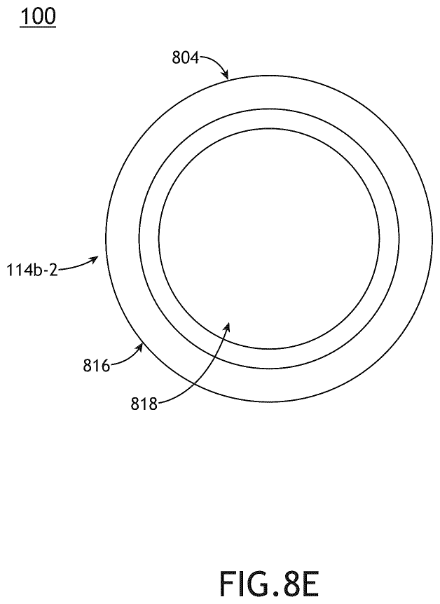

FIGS. 8A-8E depict the hanger lock joints 114b-2, in accordance with one or more embodiments of the present disclosure. The hanger lock joints 114b-2 may include a bracket 802 and hub 804. The bracket 802 may include a pair of plate portions 806 and bend portions 808. The bend portions 808 may extend between the pair of plate portions 806. The prestress strands 110 may be received by the bend portions 808 between the pair of plate portions 806. The hanger lock joints 114b-2 may then hang from the prestress strands 110. Where the bracket 802 is metal, the bracket 802 may be crimped to the prestress strands 110. Where the bracket 802 is a fiber impregnated resin material, the bracket 802 may be closed and locked with the use of a pin type lock or other method.

The pair of plate portions 806 may define a through hole 810. The hub 804 may be disposed in the through hole 810 of the pair of plate portions 806. The through hole 810 may be a notched through hole to enable inserting the hub 804 into the through hole 810 and resting the hub 804 in the notch. The pair of plate portions 806 may include a flange 812. The flange 812 may be aligned below the notch. The hub 804 may rest on the flange 812 to increase a bearing capacity of the hanger lock joints 114b-2.

The hub 804 may be made of steel, galvanized, stainless steel, resins, and the like. The hub 804 may include a center notch 814 and outer notches 816. The center notch 814 may mate to the pair of plate portions 806. For example, the center notch 814 may mate to the through hole 810 of the pair of plate portions 806. The center notch 814 may be disposed between the outer notches 816. The truss webs 112 may be wound around the hub 804 and held by the outer notches 816. The hub 818 may also define a hole in the center to lighten the hub 818 or aid in installation of the hub 818. The truss webs 112 may be bent over the hub 804 without fixing if the truss webs 112 are in tension. Thus, the hanger lock joints 114b-2 may be locked to the truss webs 112.

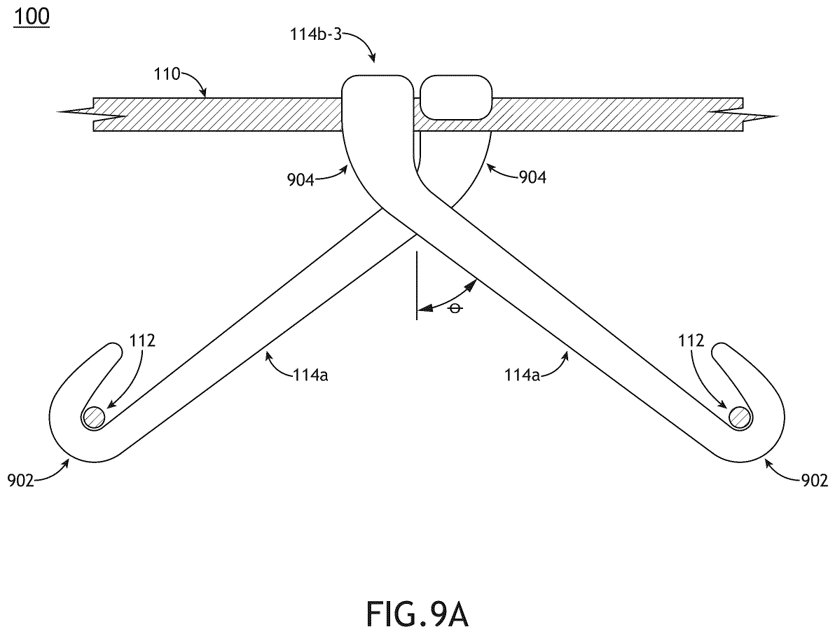

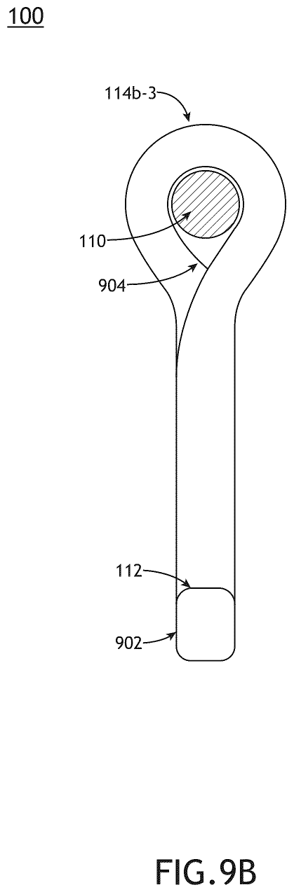

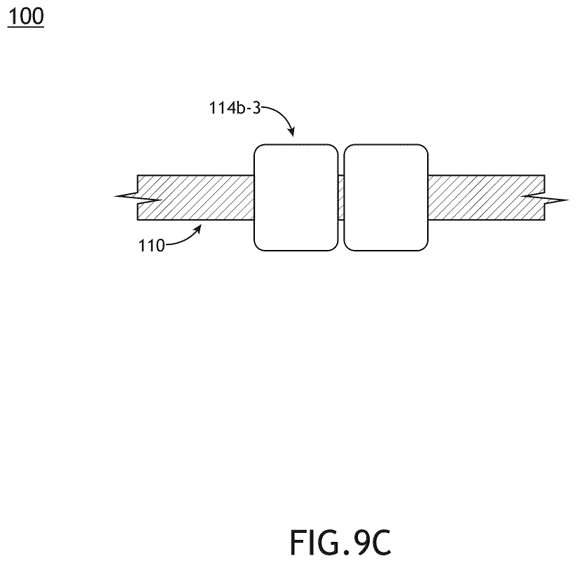

FIGS. 9A-9C depict the double-ended hook lock joints 114b-3, in accordance with one or more embodiments of the present disclosure. The double-ended hook lock joints 114b-3 may include a pair of the double-ended hook joints 114a. For example, each of the double-ended hook joints 114a may include hook ends 902 and an inside mating surface 904. The inside mating surface 904 may couple to the prestress strands 110. The inside mating surface 904 may be smooth, knurled or threaded to grip or lock onto the prestress strands 110. When the double-ended hook lock joints 114b-3 is made of metal, the double-ended hook lock joints 114b-3 may be crimped onto the prestress strands 110. The inside mating surface 904 may have a flat or nearly flat surface where a first of the double-ended hook joints 114a may abut with a second of the double-ended hook joints 114a. In this regard, the pair of double-ended hook joints 114a may abut on and/or below the prestress strands 110. The abutment between the double-ended hook joints 114a may allow the truss webs 112 on opposite sides to pull against each other and prevent or minimize movement.

The hook ends 902 may be set at an angle relative to the inside mating surface 904. For example, the hook ends 902 may be designed to have a specific angle, such as, but not limited to, be 0 degrees, 30 degrees, 45 degrees, 60 degrees, or an angle therebetween. The hook ends 902 may be set at the angle in opposing directions. The hook ends 902 may or may not include the same angle.

The hook ends 902 may couple to the truss webs 112. The hook ends 902 may include a notch that may include a radius, arc, or flat. The arc or radius may prevent the truss webs 112 from breaking. The truss webs 112 may be bent over the hook ends 902 without fixing or locking if the truss webs 112 are in tension.

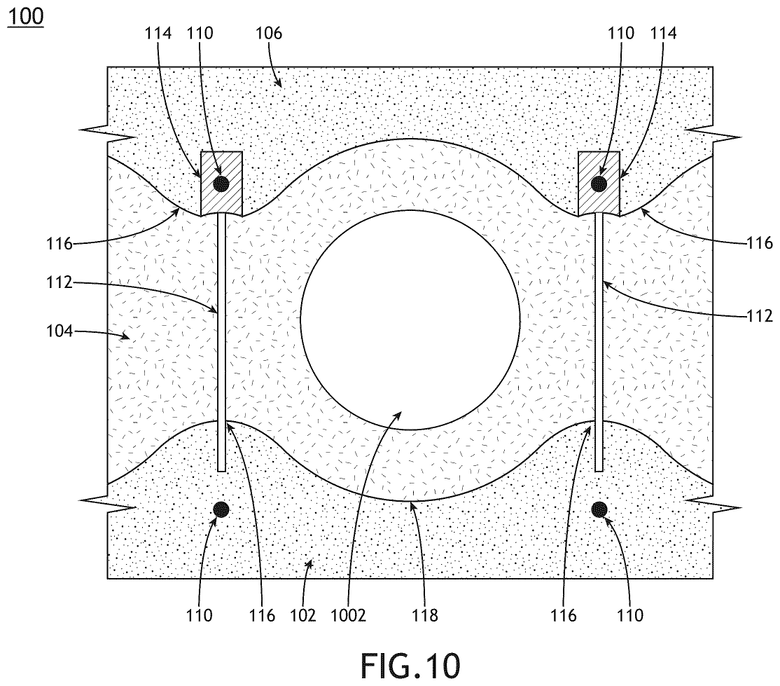

FIG. 10 depicts a partial cross-section of the composite panel 100 along a width of the composite panel 100, in accordance with one or more embodiments of the present disclosure. In embodiments, the middle insulation layer 104 may define a void space 1002. The void space 1002 may include a shape, such as, but not limited to, a circular, elliptical, or polygonal (e.g., hexagonal, octagonal, etc.). The void space 1002 may extend along the longitudinal span of the composite panel 100. The void space 1002 may define a negative, vacuum, or laminar flow air space created could be used to increase the thermal efficiency of the composite panel 100. The void space 1002 may lighten the composite panel 100. The void space 1002 may be used for creating conduits for electrical, plumbing, and other building systems. The void space 1002 may carry air for heating and ventilation purposes, insulation purposes, and the like. The void space 1002 may be sealed through chemical means (e.g., desifiers, polymer-based sealers or similar) or a pressure vessel-like form includes metal, plastic, or other similar materials suitable for pressure vessels.

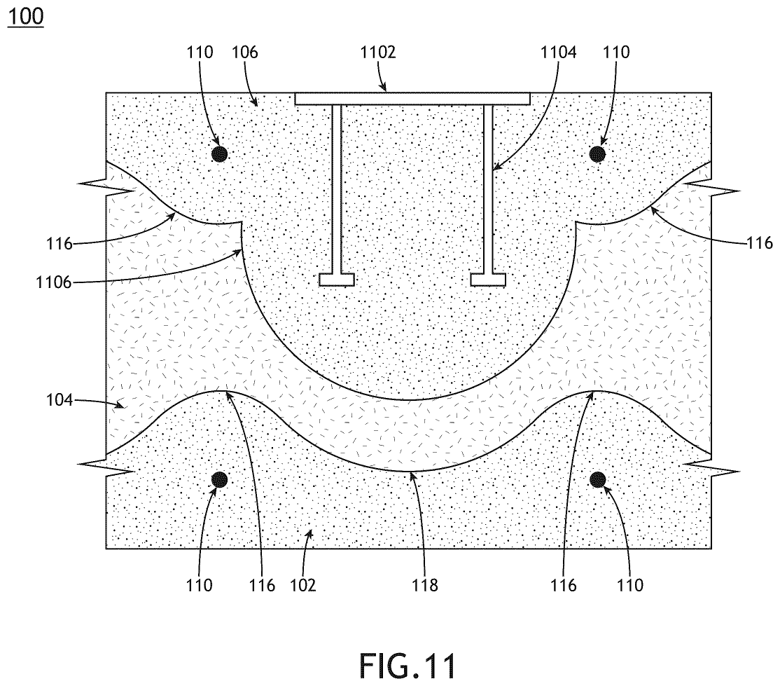

FIG. 11 depicts a partial cross-section of the composite panel 100 along a width of the composite panel 100, in accordance with one or more embodiments of the present disclosure. In embodiments, the composite panel 100 may include embed plate 1102 and headed studs 1104. A portion of the middle insulation layer 104 (with or without a void) may be removed and replaced a hump portion 1106 of the top concrete layer 106. A thickness of the top concrete layer 106 between the hump portion 1106 and the top surface may be thicker than the thickness between the ridge portion 116 and the top surface. The middle insulation layer 104 may be continuous between the bottom concrete layer 102 and the hump portion 1106 of the top concrete layer 106. The embed plate 1102 and the headed studs 1104 may be embedded into the hump portion 1106 of the top concrete layer 106. The embed plate 1102, headed studs 1104, and/or the hump portion 1106 may be disposed between a pair of the prestress strands 110.

Although the middle insulation layer 104 is described as continuous between the bottom concrete layer 102 and the hump portion 1106 of the top concrete layer 106, this is not intended as a limitation of the present disclosure. In embodiments, the middle insulation layer 104 may be removed and replaced with the hump portion 1106 (not depicted). An example where all the insulation may be removed is one where a canopy would be attached to the outside face of the building. The design loads, if high enough, may require removal of the insulation in certain locations.

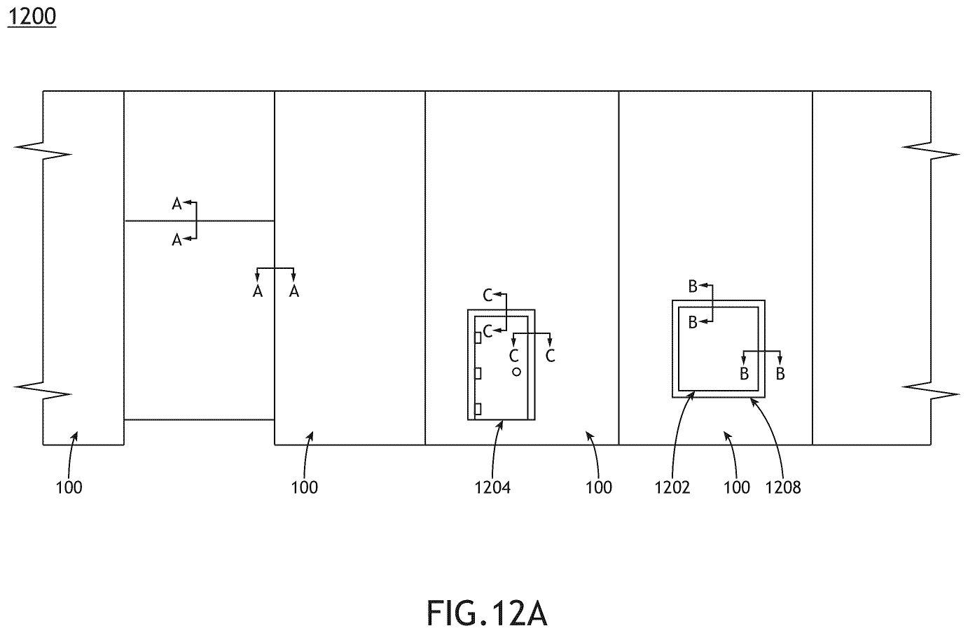

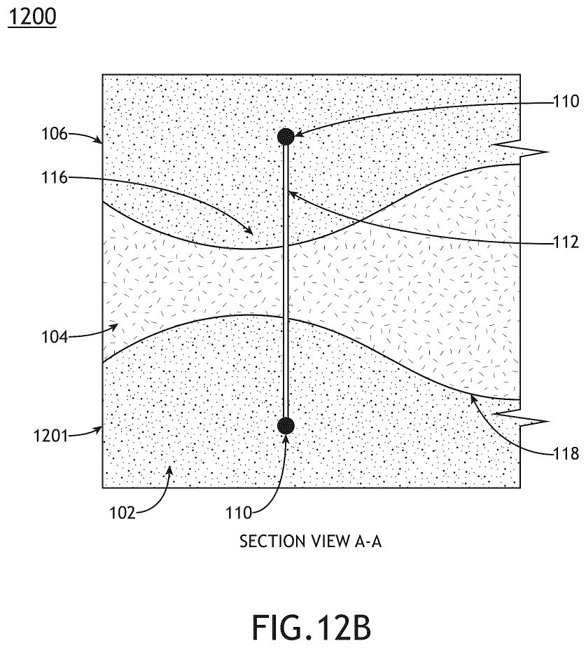

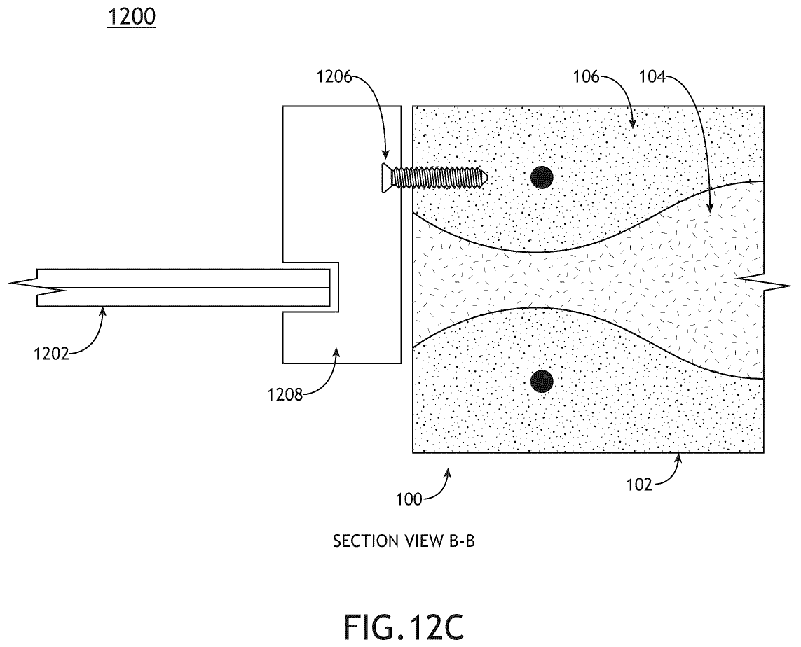

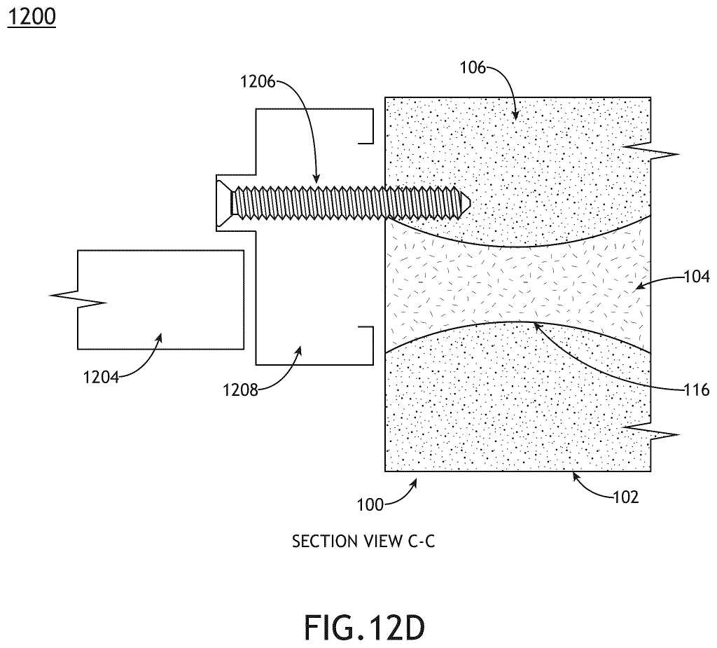

FIGS. 12A-12D depict a system 1200, in accordance with one or more embodiments of the present disclosure. In embodiments, the system 1200 may include the composite panels 100, windows 1202, doors 1204, fasteners 1206, frames 1208, and the like. The composite panels 100 may include an edge 1201. The edge 1201 may allow for coupling the window 1202 and door 1204 to the composite panel 100. The edge 1201 may include the bottom concrete layer 102, the middle insulation layer 104, and the top concrete layer 106. The middle insulation layer 104 may be maintained while allowing for the window 1202, door 1204, fasteners 1206, frames 1208, caulk, and the like.

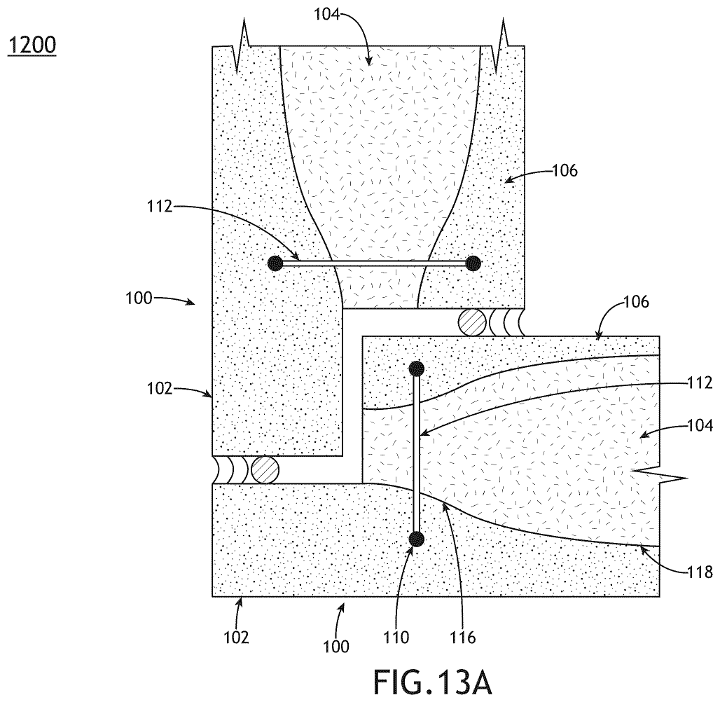

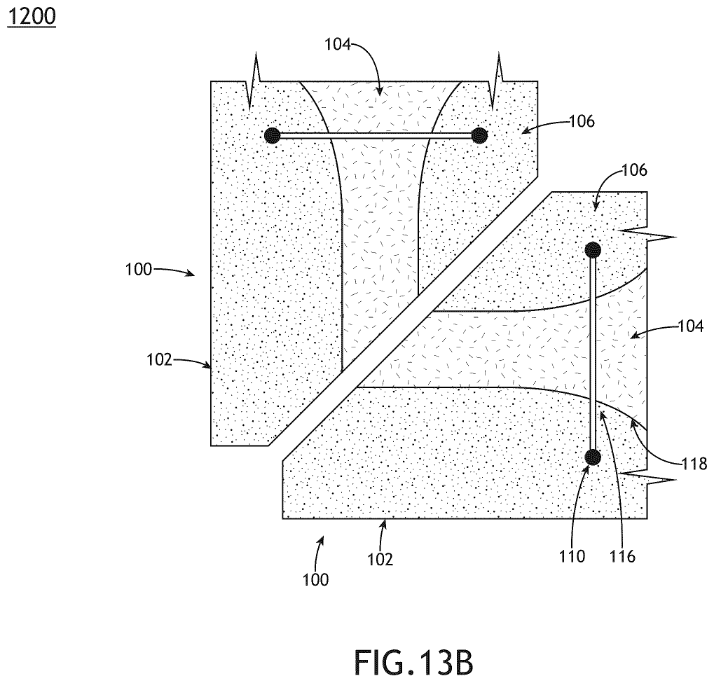

FIG. 13A-13B depict the system 1200, in accordance with one or more embodiments of the present disclosure. A first of the composite panels 100 may be orthogonal to a second of the composite panels 100. The composite panels 100 may include one or more corner joints. The corner joints may maintain the edge-to-edge insulation of the building envelope required per the code. The middle insulation layer 104 of a first of the composite panels 100 may be covered by the bottom concrete layer 102, the middle insulation layer 104, and/or the top concrete layer 106 of a second of the composite panels 100. The corner joints may be formed during casting or fabricated after by saw cutting. FIG. 13A depicts the corner joints of the composite panels 100 with a lap joint. FIG. 13B depicts the corner joints of the composite panels 100 with a mitered joint. The mitered joint may be advantageous to abut the middle insulation layers 104 of the composite panels 100.

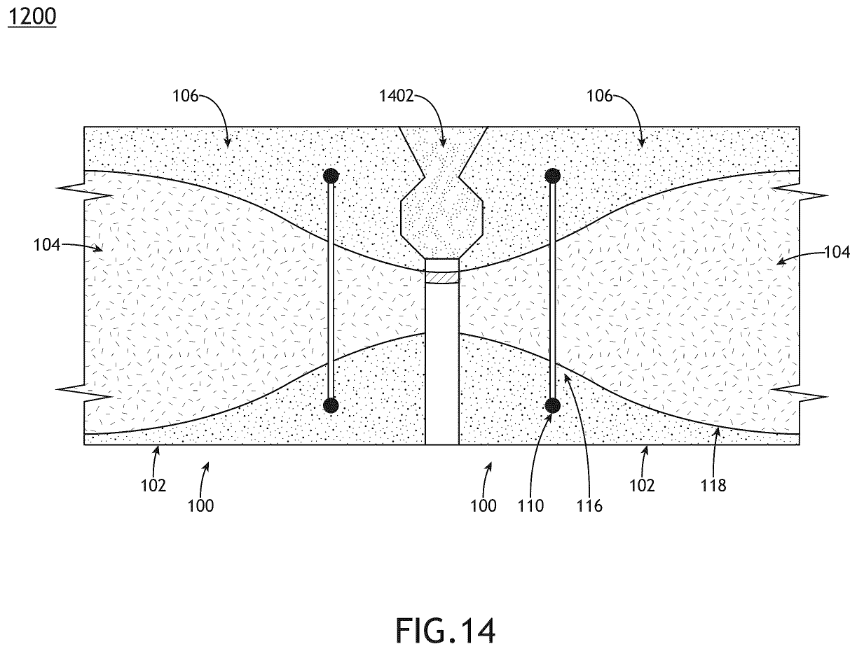

FIG. 14 depict the system 1200, in accordance with one or more embodiments of the present disclosure. A first of the composite panels 100 may be coincident to a second of the composite panels 100. The system 1200 may include a grout key 1402. The grout key 1402 may be disposed between the composite panels 100. The grout key 1402 may transfer shear between the composite panels 100. The grout key 1402 may include, but is not limited to a female-to-female configuration (as depicted) or a male-to-female configuration. The grout key 1402 may be coupled between the top concrete layers 106 of the composite panels 100. The location of the grout key 1402 in the top concrete layers 106 of the composite panels 100 may enable maintaining edge-to-edge insulation. For example, the middle insulation layers 104 of the composite panels 100 may abut and be disposed between the concrete layers.

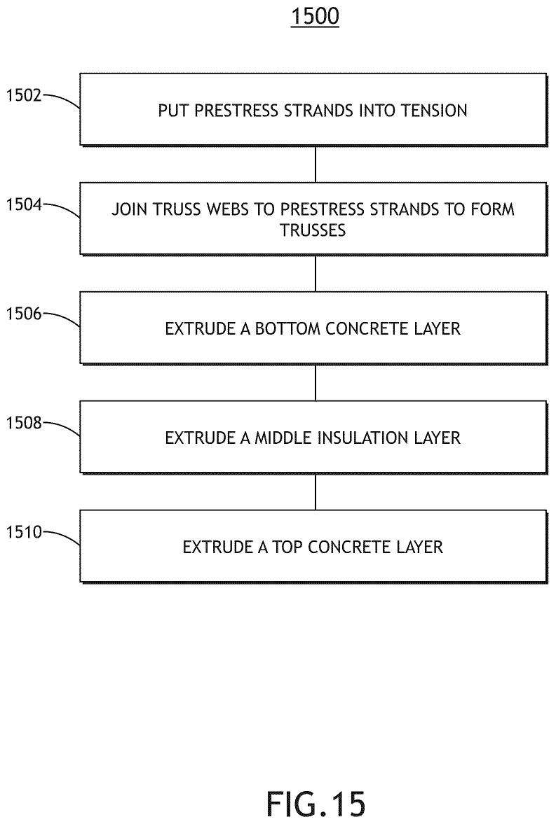

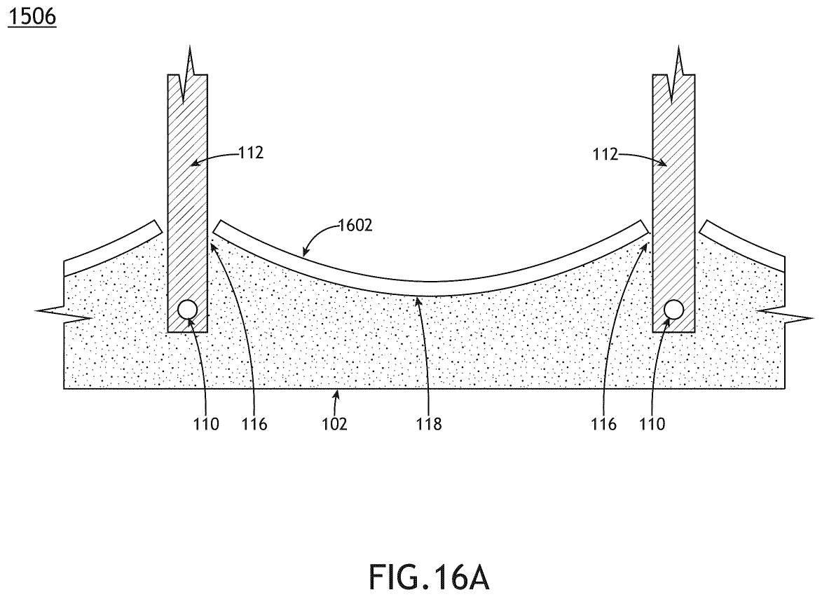

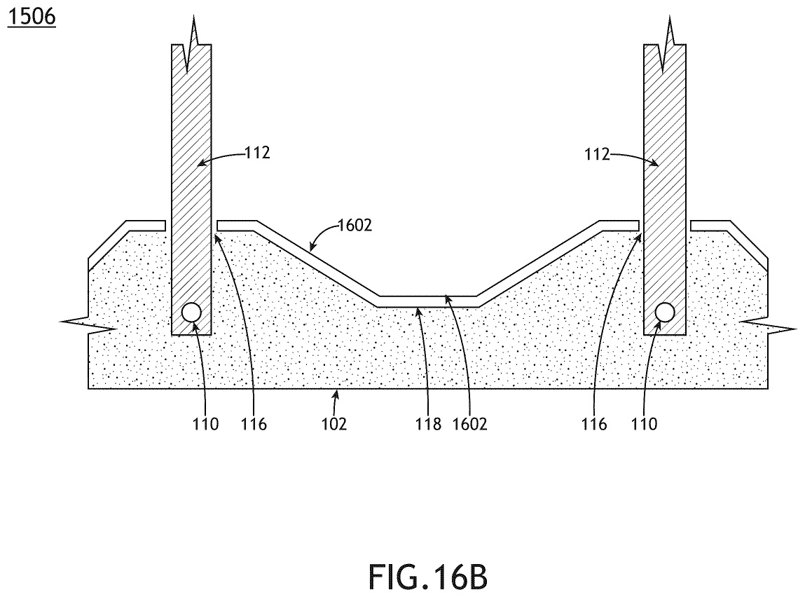

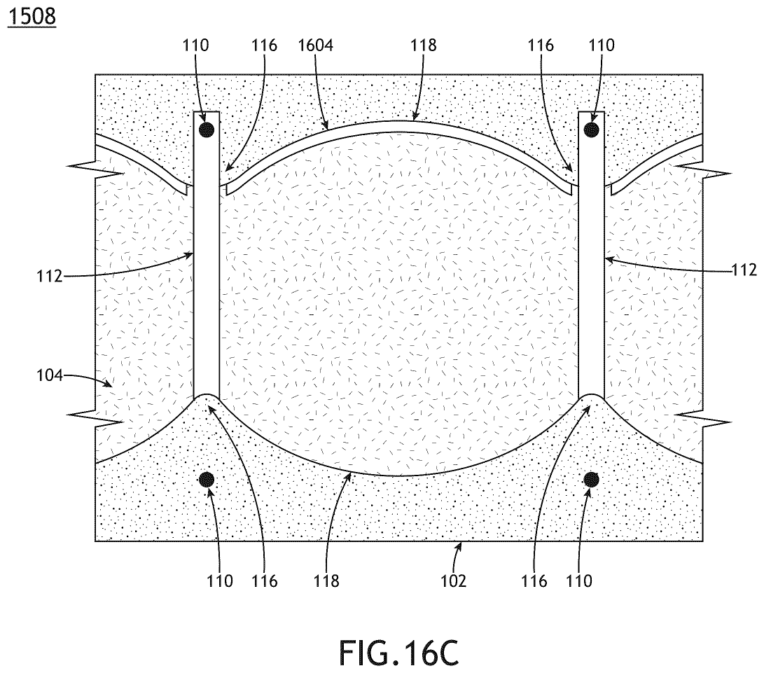

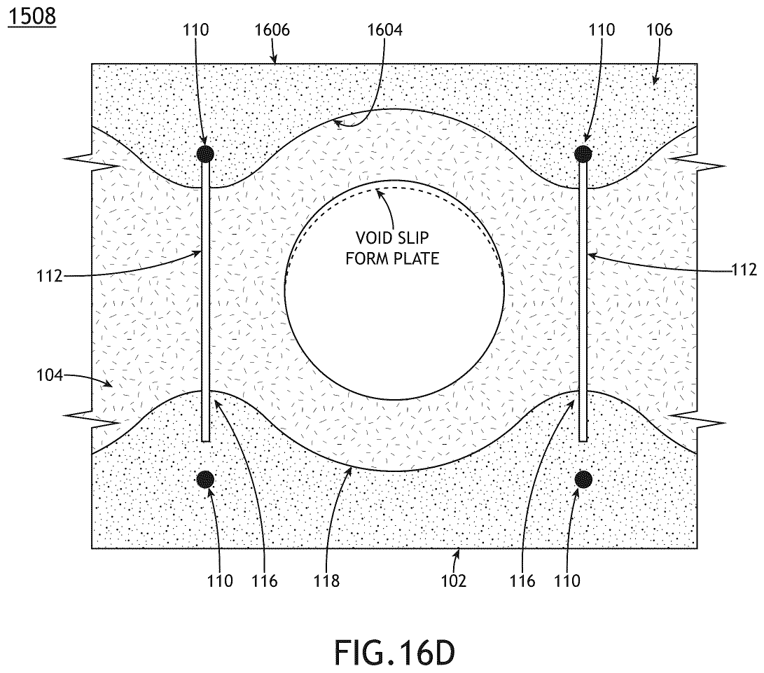

Referring now to FIG. 15, a method 1500 is described, in accordance with one or more embodiments of the present disclosure. The embodiments and the enabling technology described previously herein in the context of the composite panel 100 should be interpreted to extend to the method 1500. For example, the method 1500 may be a method of manufacturing the composite panel 100. It is further recognized, however, that the method 1500 is not limited to the composite panel 100. The method 1500 may include automatically or semi-automatically manufacturing the composite panel 100 using one or more pre-cast extrusion machines. The steps of the method 1500 may be further understood with reference to the examples provide in FIGS. 16A-16D.

In a step 1502, prestress strands may be put into tension. The prestress strands may include pairs of prestress strands which are arranged in linear arrays for a select length. For example, pairs of the prestress strands 110 may be put into tension along the length of the composite panel 100. Putting the prestress strands 110 into strain may include elongating the prestress strands 110.

In a step 1504, truss webs may be joined to the prestress strands using joints to form trusses. The joints may receive the truss webs and the prestress strands. For example, the truss webs 112 may be joined to the prestress strands 110 using the joints 114 to form the trusses 108. For instance, the continuous truss webs 112a and/or the segmented truss webs 112b may be joined to the prestress strands 110 using the double-ended hook joints 114a and/or the lock joints 114b to form the trusses 108. Thus, the trusses 108 may be put in place prior to the extruding of the bottom concrete layer 102, the middle insulation layer 104, and the top concrete layer 106.

In a step 1506, a bottom concrete layer may be extruded. For example, the bottom concrete layer 102 may be extruded. The bottom concrete layer 102 may be formed by bottom form plates 1602. The bottom form plates 1602 may define the ridge portions 116 and ditch portions 118 of the bottom concrete layer 102. For example, the bottom form plates 1602 may include a flat shape, an arc shape, a polygonal shape (e.g., trapezoid), or the like to define the ridge portions 116 and ditch portions 118. For instance, FIGS. 16A-16B depict shapes of the bottom form plates 1602. The bottom form plates 1602 may travel along the longitudinal span between the trusses 108 without interfering with the trusses 108 (e.g., without entering interference zones including the trusses 108). The bottom form plates 1602 may use pressure and/or vibration to compact the concrete material into the bottom concrete layer 102. The bottom concrete layer 102 may be extruded around the prestress strands 110, the truss webs 112, and/or the joints 114.

In a step 1508, a middle insulation layer may be extruded. For example, the middle insulation layer 104 may be extruded. The middle insulation layer 104 may be formed by middle form plates 1604. The middle form plates 1604 may define the ridge portions 116 and ditch portions 118 between the middle insulation layer 104 and the top concrete layer 106. For example, the middle form plates 1604 may include a flat shape, an arc shape, a polygonal shape (e.g., trapezoid), or the like to define the ridge portions 116 and ditch portions 118. For instance, FIG. 16C depict arc shapes of the middle form plates 1604. The middle form plates 1604 may travel along the longitudinal span between the trusses 108 without interfering with the trusses 108 (e.g., without entering interference zones including the trusses 108). The middle form plates 1604 may use pressure and/or vibration to compact the insulation material into the middle insulation layer 104. The middle insulation layer 104 may be extruded around the prestress strands 110, the truss webs 112, and/or the joints 114.

During the placement and consolidation of the middle insulation layer 104, the concrete material of the bottom concrete layer 102 may mix with the insulation material of the middle insulation layer 104. In embodiments, the bottom form plates 1602 may be used in combination with the middle form plates 1604 for part, or none of the slip form process. Using the bottom form plates 1602 may be utilized in combination with the middle form plates 1604 may reduce the mixing between the bottom concrete layer 102 and the middle insulation layer 104. For example, the bottom form plates 1602 may prevent disturbing the bottom concrete layer 102 when extruding the middle insulation layer 104 with the middle form plates 1604.

In a step 1510, a top concrete layer may be extruded. For example, the top concrete layer 106 may be extruded. The top concrete layer 106 may be formed by top form plates 1606. The top form plates 1606 may define the top surface of the top concrete layer 106. For example, the top form plates 1606 may include a flat shape. For instance, FIG. 16D depicts the flat shape of the top form plates 1606. The top form plates 1606 may use pressure and/or vibration to compact the concrete material into the top concrete layer 106. The top concrete layer 106 may be extruded around the prestress strands 110, the truss webs 112, and/or the joints 114.

During the placement and consolidation of the top concrete layer 106, the concrete material of the bottom concrete layer 102 may mix with the insulation material of the middle insulation layer 104 and/or the insulation material of the middle insulation layer 104 may mix with the concrete material of the top concrete layer 106. In embodiments, the bottom form plates 1602 and/or the middle form plates 1604 may be used in combination with the top form plates 1606 for part, or none of the slip form process. Using the bottom form plates 1602 and/or the middle form plates 1604 in combination with the top form plates 1606 may reduce the mixing between the bottom concrete layer 102, the middle insulation layer 104, and the top concrete layer 106. For example, the bottom form plates 1602 and middle form plates 1604 may prevent disturbing the bottom concrete layer 102 and middle insulation layer 104, respectively, when extruding the top concrete layer 106 with the top form plates 1606.

In embodiments, the void space 1002 may have all, some, or none of a void form plate to hold the insulation material in place while the top concrete layer 106 is being extruded. The void space 1002 may be formed at the same time as the middle insulation layer 104 and/or the top concrete layer 106 is being extruded and compressed. The void space 1002 could be plugged at the end after the composite panel 100 is cut to length and stripped.

In embodiments, the bottom concrete layer 102, the middle insulation layer 104, and/or the top concrete layer 106 may be manufactured in one long extrusion. For example, the steps of extruding the bottom concrete layer 102, the middle insulation layer 104, and/or the top concrete layer 106 may be simultaneous or near-simultaneous. In embodiments, a machine may simultaneously or near-simultaneously extrude the bottom concrete layer 102, the middle insulation layer 104, and/or the top concrete layer 106. Near-simultaneously may refer to beginning to extrude the bottom concrete layer 102, the middle insulation layer 104, and/or the top concrete layer 106 within several feet of each other, or less. To achieve the extrusion, the machine may include multiple hoppers containing the materials and distributing the materials into the layers. Alternatively, two or three of the machines may distribute the materials into the layers in succession to create the composite panel 100.

Although the step 1506, the step 1508, and the step 1510 are described as extruding the bottom concrete layer 102, the middle insulation layer 104, and the top concrete layer 106, respectively, this is not intended as a limitation of the present disclosure. It is contemplated that the step 1506, the step 1508, and the step 1510 may be replaced with pouring the bottom concrete layer 102, the middle insulation layer 104, and the top concrete layer 106, respectively. Where the bottom concrete layer 102, the middle insulation layer 104, and the top concrete layer 106, the concrete material of the bottom concrete layer 102, the middle insulation layer 104, and the top concrete layer 106 may be high-slump concrete which may be consolidated in formworks to form the bottom concrete layer 102, the middle insulation layer 104.

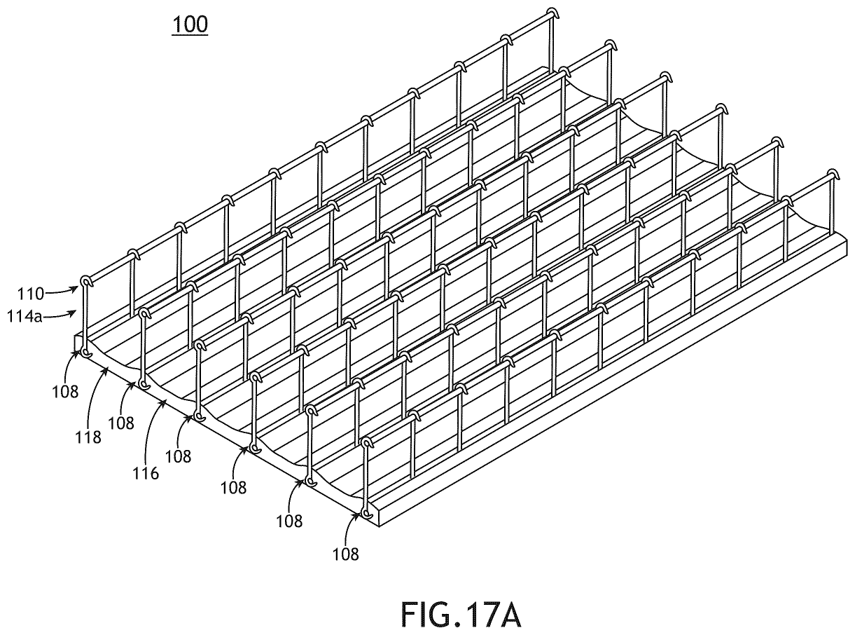

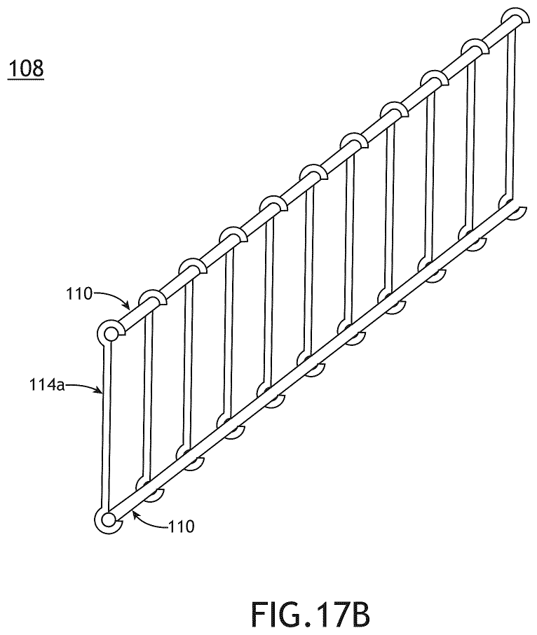

FIG. 17A-17B depicts the composite panel 100, in accordance with one or more embodiments of the present disclosure. Although the trusses 108 have been described as including the truss webs 112, this is not intended as a limitation of the present disclosure. In embodiments, the trusses 108 may include the prestress strands 110 and the joints 114. The joints 114 may couple directly between the prestress strands 110 in the bottom concrete layer 102 and the prestress strands 110 in the top concrete layer 106 through the middle insulation layer 104. In this regard, the joints 114 may extend from prestress strands 110 to prestress strands 110 without the truss webs 112. It is contemplated that any of the designs of the joints 114 may couple directly between the prestress strands 110 in the bottom concrete layer 102 and the prestress strands 110 in the top concrete layer 106. For example, the double-ended hook joints 114a may couple directly between the prestress strands 110 in the bottom concrete layer 102 and the prestress strands 110 in the top concrete layer 106. The lock joints 114b (e.g., the truss lock joints 114b-1, hanger lock joints 114b-2, double-ended hook lock joints 114b-3) may or may not be able to couple directly between the prestress strands 110 in the bottom concrete layer 102 and the prestress strands 110 in the top concrete layer 106.

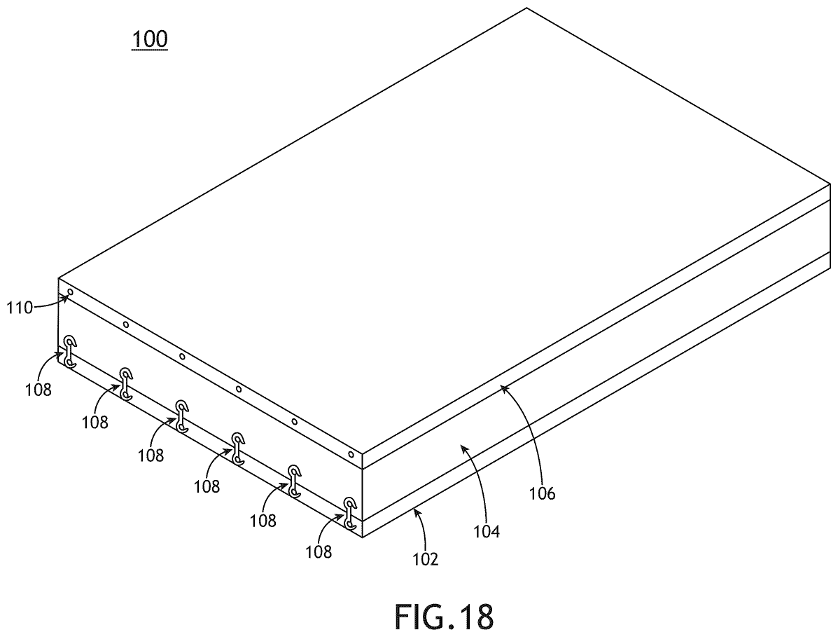

FIG. 18 depicts the composite panel 100, in accordance with one or more embodiments of the present disclosure. Although the top surface of the bottom concrete layer 102 and the bottom surface of the top concrete layer 106 are described as including the ridge portions 116 and/or ditch portions 118, this is not intended as a limitation of the present disclosure. For example, the top surface of the bottom concrete layer 102 and the bottom surface of the top concrete layer 106 may be flat. However, the addition of the ridge portions 116 and/or ditch portions 118 may be beneficial to reduce a weight and/or improve a strength of the composite panel 100.

Referring generally again to the figures. The composite panel 100 may have the ability to carry loads from wind, snow, seismic and other live and environmental loads. The composite panel 100 may take dead loads imposed on the composite panel 100. The building code also includes provisions for thermal insulation of the building envelope. The composite panel 100 may be used as exterior walls and/or roof members and may include the insulation properties necessary to meet or exceed the code. The composite panel 100 may achieve the desired design and code requirements by varying the thickness of the bottom concrete layer 102, the middle insulation layer 104, and/or the top concrete layer 106, varying the number and size of the prestress strands 110, and/or varying the configuration of the trusses 108.

Although the composite panel 100 is described as including the prestress strands 110, this is not intended as a limitation of the present disclosure. The prestress strands 110 may be replaced with plain or non-prestressed reinforcement bars (rebar). However, the rebar may raise additional challenges in the manufacture of the composite panel 100.

It is further contemplated that each of the embodiments of the methods described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mixable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A composite panel comprising:
a bottom concrete layer;
a top concrete layer;
a middle insulation layer, wherein the middle insulation layer is disposed between the bottom concrete layer and the top concrete layer; and
a plurality of trusses, wherein the plurality of trusses include:
a plurality of prestress strands;
a plurality of truss webs, wherein the plurality of truss webs are disposed in the middle insulation layer, wherein the bottom concrete layer, the middle insulation layer, the top concrete layer, the plurality of prestress strands, and the plurality of truss webs extend along a longitudinal span of the composite panel; and
a plurality of joints, wherein the plurality of prestress strands and the plurality of joints are disposed in the bottom concrete layer and the top concrete layer, wherein the plurality of joints join the plurality of truss webs to the plurality of prestress strands.

2. The composite panel of claim 1, wherein the composite panel is at least one of a composite slab panel, a composite wall panel, a composite roof slab, a slab-on-grade, or a suspended slab.

3. The composite panel of claim 1, wherein a density of the middle insulation layer is less than densities of the bottom concrete layer and the top concrete layer, wherein an R-value of the middle insulation layer is more than R-values of the bottom concrete layer and the top concrete layer, wherein a compressive strength of the middle insulation layer is less than compressive strengths of the bottom concrete layer and the top concrete layer.

4. The composite panel of claim 1, wherein the middle insulation layer is made of an insulation material, wherein a space between the plurality of truss webs is filled with the insulation material of the middle insulation layer.

5. The composite panel of claim 4, wherein a composition of the insulation material includes cementitious material.

6. The composite panel of claim 5, wherein the insulation material includes one of a hemp-based insulation material, an aerated zero-slump concrete, a cellular concrete, a pervious concrete, or a Styrofoam aggregate concrete.

7. The composite panel of claim 1, wherein the plurality of truss webs are tension wires, wherein the tension wires do not carry compressive forces between the bottom concrete layer and the top concrete layer, wherein the compressive forces are transferred between the bottom concrete layer and the top concrete layer via the middle insulation layer.

8. The composite panel of claim 1, wherein the plurality of joints extend into the middle insulation layer, wherein the plurality of truss webs do not extend into the bottom concrete layer and the top concrete layer, wherein the plurality of truss webs are coupled to the plurality of joints in the middle insulation layer, wherein a thermal conductivity of the plurality of joints is less than a thermal conductivity of the plurality of truss webs.

9. The composite panel of claim 1, wherein the plurality of joints do not extend into the middle insulation layer, wherein the plurality of truss webs extend into the bottom concrete layer and the top concrete layer, wherein the plurality of truss webs are coupled to the plurality of joints in the bottom concrete layer and the top concrete layer, wherein a thermal conductivity of the plurality of truss webs is less than a thermal conductivity of the plurality of joints.

10. The composite panel of claim 1, wherein the plurality of truss webs are a plurality of continuous truss webs.

11. The composite panel of claim 1, wherein the plurality of truss webs are a plurality of segmented truss webs, wherein the plurality of segmented truss webs include a plurality of segments, wherein individual of the plurality of segments do not extend along the longitudinal span, wherein the plurality of segments connect to form the plurality of segmented truss webs and cooperatively extend along the longitudinal span, wherein the plurality of segments connect between at least one of the plurality of joints in the bottom concrete layer and at least one of the plurality of joints in the top concrete layer.

12. The composite panel of claim 11, wherein the plurality of segments connect between at least three of the plurality of joints.

13. The composite panel of claim 11, wherein the plurality of segmented truss webs are a plurality of open-looped segmented truss webs.

14. The composite panel of claim 11, wherein the plurality of segmented truss webs are a plurality of double-looped segmented truss webs.

15. The composite panel of claim 1, wherein the plurality of joints include double-ended hook joints.

16. The composite panel of claim 15, wherein the double-ended hook joints include at least one of ε-shaped hooks or S-shaped hooks.

17. The composite panel of claim 1, wherein the plurality of joints include lock joints, wherein the lock joints are locked to at least one of the plurality of prestress strands or the plurality of truss webs.

18. The composite panel of claim 17, wherein the lock joints include truss lock joints, wherein the truss lock joints include a hook end and a hub end, wherein the hook end couples to the plurality of prestress strands, wherein the hub end couples to the plurality of truss webs, wherein the truss lock joints are locked to the plurality of truss webs.

19. The composite panel of claim 17, wherein the lock joints include hanger lock joints, wherein the hanger lock joints include a bracket and a hub, wherein the bracket includes a pair of plate portions and a bend portion, wherein the bend portion extends between the pair of plate portions, wherein the plurality of prestress strands are received by the bend portion between the pair of plate portions, wherein the pair of plate portions define a through hole, wherein the hub is disposed in the through hole, wherein the plurality of truss webs are wound around the hub, wherein the hanger lock joints are locked to the plurality of truss webs.

20. The composite panel of claim 17, wherein the lock joints include double-ended hook lock joints, wherein the double-ended hook lock joints are locked to the plurality of prestress strands.

21. The composite panel of claim 1, wherein a top surface of the bottom concrete layer and a bottom surface of the top concrete layer include ridge portions and ditch portions, wherein the ridge portions and the ditch portions extend along the longitudinal span of the composite panel, wherein the ditch portions connect between the ridge portions, wherein the bottom concrete layer and the top concrete layer are thicker along the ridge portions than along the ditch portions.

22. The composite panel of claim 21, wherein the ridge portions and the ditch portions are arranged in a linear array along a width of the composite panel.

23. The composite panel of claim 21, wherein the ridge portions of the bottom concrete layer align with the ridge portions of the top concrete layer, wherein the ditch portions of the bottom concrete layer align with the ditch portions of the top concrete layer, wherein the ridge portions and the plurality of trusses are aligned.

24. The composite panel of claim 1, wherein a top surface of the bottom concrete layer and a bottom surface of the top concrete layer are flat.

25. The composite panel of claim 1, wherein the middle insulation layer defines a void space, wherein the void space extends along the longitudinal span.

26. The composite panel of claim 1, comprising an embed plate and headed studs, wherein the embed plate and the headed studs are embedded in the top concrete layer.

27. A system comprising:
a first composite panel and a second composite panel, wherein the first composite panel and the second composite panel comprise:
a bottom concrete layer;
a top concrete layer;
a middle insulation layer, wherein the middle insulation layer is disposed between the bottom concrete layer and the top concrete layer; and
a plurality of trusses, wherein the plurality of trusses include:
a plurality of prestress strands;
a plurality of truss webs, wherein the plurality of truss webs are disposed in the middle insulation layer, wherein the bottom concrete layer, the middle insulation layer, the top concrete layer, the plurality of prestress strands, and the plurality of truss webs extend along a longitudinal span of the composite panel; and
a plurality of joints, wherein the plurality of prestress strands and the plurality of joints are disposed in the bottom concrete layer and the top concrete layer, wherein the plurality of joints join the plurality of truss webs to the plurality of prestress strands.

28. The system of claim 1, wherein the first composite panel is orthogonal to the second composite panel, wherein the first composite panel and the second composite panel include a mitered joint, wherein the middle insulation layer of the first composite panel abuts the middle insulation layer of the second composite panel.

29. The system of claim 1, wherein the first composite panel is coincident to the second composite panel, wherein the middle insulation layer of the first composite panel abuts the middle insulation layer of the second composite panel.

30. A method of manufacturing a composite panel, the method comprising:
putting a plurality of prestress strands into tension;
joining a plurality of truss webs to the plurality of prestress strands by a plurality of joints to form a plurality of trusses;
extruding a bottom concrete layer;
extruding a middle insulation layer, wherein the plurality of truss webs are disposed in the middle insulation layer; and
extruding a top concrete layer, wherein the middle insulation layer is disposed between the bottom concrete layer and the top concrete layer, wherein the plurality of prestress strands and the plurality of joints are disposed in the bottom concrete layer and the top concrete layer, wherein the bottom concrete layer, the middle insulation layer, the top concrete layer, the plurality of prestress strands, and the plurality of truss webs extend along a longitudinal span of the composite panel.

31. A composite panel comprising:
a bottom concrete layer;
a top concrete layer; and
a middle insulation layer, wherein the middle insulation layer is disposed between the bottom concrete layer and the top concrete layer; and
a plurality of trusses, wherein the plurality of trusses include:
a plurality of prestress strands, wherein the bottom concrete layer, the middle insulation layer, the top concrete layer, and the prestress strands extend along a longitudinal span of the composite panel; and
a plurality of joints, wherein the plurality of prestress strands and the plurality of joints are disposed in the bottom concrete layer and the top concrete layer, wherein the plurality of joints couple directly between the plurality of prestress strands in the bottom concrete layer and the plurality of prestress strands in the top concrete layer through the middle insulation layer.
